(19) United States
(12) Patent Application Publication
(10) Pub. No.: US 2024/0218727 A1
(43) Pub. Date: Jul. 4, 2024

(54) DIAGNOSTIC APPARATUS, DIAGNOSTIC SYSTEM, AND DIAGNOSTIC METHOD

(71) Applicant: FUJI ELECTRIC CO., LTD., Kanagawa (JP)

(72) Inventor: Shinji YUKAWA, Mie (JP)

(21) Appl. No.: 18/492,057

(22) Filed: Oct. 23, 2023

(30) Foreign Application Priority Data
Dec. 28, 2022 (JP) 2022-212721

(51) Int. Cl. E05F 15/659; E05F 15/635

(52) U.S. Cl. CPC E05F 15/659; E05F 15/635; E05Y 2201/606; E05Y 2400/502; E05Y 2900/51

(57) ABSTRACT

A diagnostic apparatus includes a drive mechanism configured to open or close a door panel, and includes a fastening mechanism configured to fasten the door panel to the drive mechanism. The diagnostic apparatus includes circuitry configured to acquire first data related to an operation of a door of a train carriage, during at least one of an opening operation or a closing operation of the door, and to diagnose an abnormality in the fastening mechanism based on the acquired first data.

### CROSS-REFERENCE TO RELATED APPLICATION

This application claims priority to Japanese Patent Application No. 2022-212721, filed on Dec. 28, 2022, the entire contents of which are incorporated herein by reference.

### BACKGROUND

### 1. Field of the Invention

The present disclosure relates to a diagnostic apparatus and the like.

### 2. Description of the Related Art

There are known techniques that diagnose anomalies in a door of a train carriage (see Patent Document 1).

### RELATED-ART DOCUMENT

### Patent Document

[Patent Document 1] Japanese Unexamined Patent Application Publication No. 2012-197144

### SUMMARY

In a first aspect of the present disclosure, a diagnostic apparatus is provided. The diagnostic apparatus includes a drive mechanism configured to open or close a door panel; a fastening mechanism configured to fasten the door panel to the drive mechanism; and circuitry configured to acquire first data related to an operation of a door of a train carriage during at least one of an opening operation or a closing operation of the door and to diagnose an abnormality in the fastening mechanism based on the acquired data.

In a second aspect of the present disclosure, a diagnostic system is provided. The diagnostic system includes a drive mechanism configured to open or close a door panel; a fastening mechanism configured to fasten the door panel to the drive mechanism; and circuitry configured to perform at least one of an opening operation or a closing operation of a door of a train carriage, acquire first data related to the operation of the door during the at least one of the opening operation or the closing operation, and diagnose an abnormality in the fastening mechanism based on the acquired first data.

In a third aspect of the present disclosure, a diagnostic method executed by a computer is provided. The diagnostic method includes acquiring first data related to an operation of a door during at least one of an opening operation or a closing operation; and diagnosing, based on the acquired first data, an abnormality in a fastening mechanism configured to fasten a door panel to a drive mechanism that opens or closes the door panel.

In a fourth aspect of the present disclosure, a non-transitory computer readable medium storing a program for causing a computer to execute the diagnostic method in the third aspect is provided.

### BRIEF DESCRIPTION OF THE DRAWINGS

FIG. 1 is a block diagram illustrating a configuration example associated with an opening-and-closing operation of a door of a train carriage.

FIG. 2 is a schematic diagram illustrating an example of an arrangement structure of the door and the door drive mechanism of the train carriage.

FIG. 3 is a schematic diagram illustrating an example of the arrangement structure of the door and the door drive mechanism of the train carriage.

FIG. 4 is a schematic diagram illustrating an example of the arrangement structure of the door and the door drive mechanism of the train carriage.

FIG. 5 is a schematic diagram illustrating an example of the arrangement structure of the door and the door drive mechanism of the train carriage.

FIG. 6 is a schematic diagram illustrating an example of the arrangement structure of the door and the door drive mechanism of the train carriage.

FIG. 7 is a diagram illustrating an example of fastening mechanisms that fasten respective door panels to the door drive mechanism.

FIG. 8 is a diagram illustrating an example of temporal changes in a door position, a speed of the door, and a motor current during closing of the door, in a case where the fastening mechanisms to fasten the respective door panels to the door drive mechanism are under a normal condition.

FIG. 9 is a diagram illustrating an example of temporal changes in the door position, the door speed, and the motor current during closing of the door, in a case where one or more fastening mechanisms to fasten the respective door panels to the door drive mechanism are under an abnormal condition.

FIG. 10 is a diagram for describing a first example of a frequency analysis result that is derived from time series data of the current during opening of the door.

FIG. 11 is a diagram for describing a second example of a frequency analysis result that is derived from time series data of the data during opening of the door.

FIG. 12 is a diagram for describing a first example of a diagnostic mode in which the door moves.

FIG. 13 is a diagram for describing a second example of the diagnostic mode in which the door moves.

FIG. 14 is a sequence diagram illustrating a first example of an abnormality diagnosis process for the door.

FIG. 15 is a sequence diagram illustrating a second example of the abnormality diagnosis process for the door.

FIG. 16 is a sequence diagram illustrating a third example of the abnormality diagnosis process for the door.

FIG. 17 is a diagram illustrating another example of a diagnostic system.

FIG. 18 is a sequence diagram illustrating a fourth example of the abnormality diagnosis process for the door.

FIG. 19 is a diagram illustrating still another example of the diagnostic system.

FIG. 20 is a sequence diagram illustrating a fifth example of the abnormality diagnosis process for the door.

### DETAILED DESCRIPTION

Related art information relevant to the present disclosure recognized by the inventor of this application is provided below. Patent Document 1 described above does not disclose diagnosing abnormalities in a fastening mechanism that fastens door panels to a drive mechanism for opening or closing the door panels. Thus, the abnormalities in the fastening mechanism cannot be diagnosed.

Therefore, in view of the above issue recognized by the inventor, an object of the present disclosure is to provide a technique capable of diagnosing an abnormality in a fastening mechanism between a door panel and a drive mechanism for opening or closing the door panel.

Hereinafter, one or more embodiments will be described with reference to the drawings.

### Configuration Associated With Opening and Closing of Door

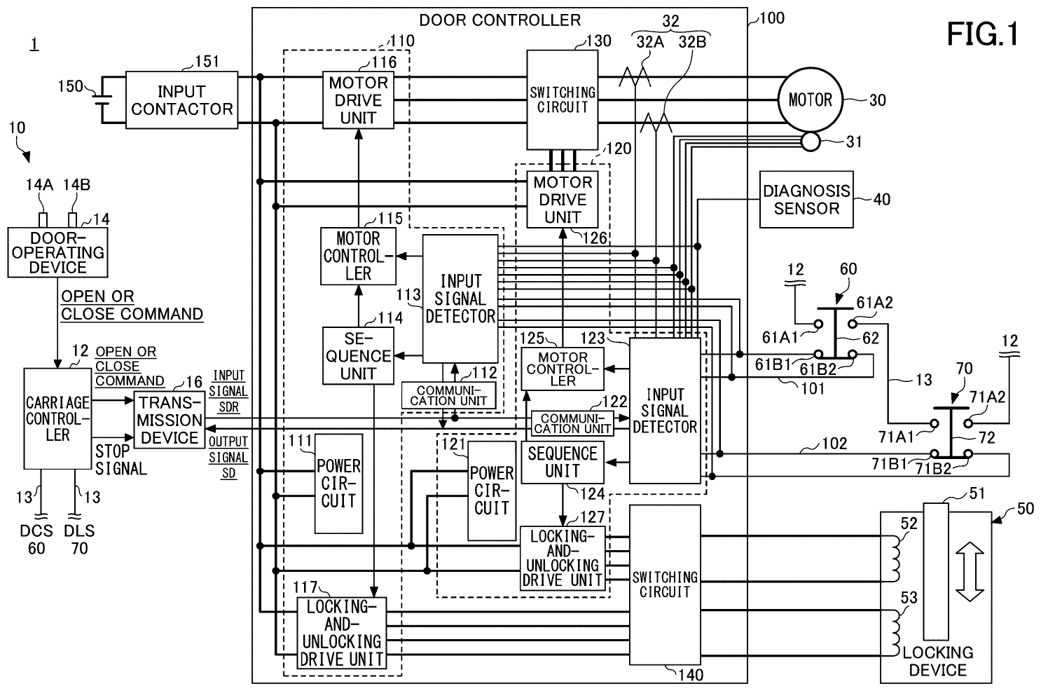

An example of the configuration associated with opening and closing of a door 80 in a train carriage 1 will be described below with reference to FIGS. 1 to 6.

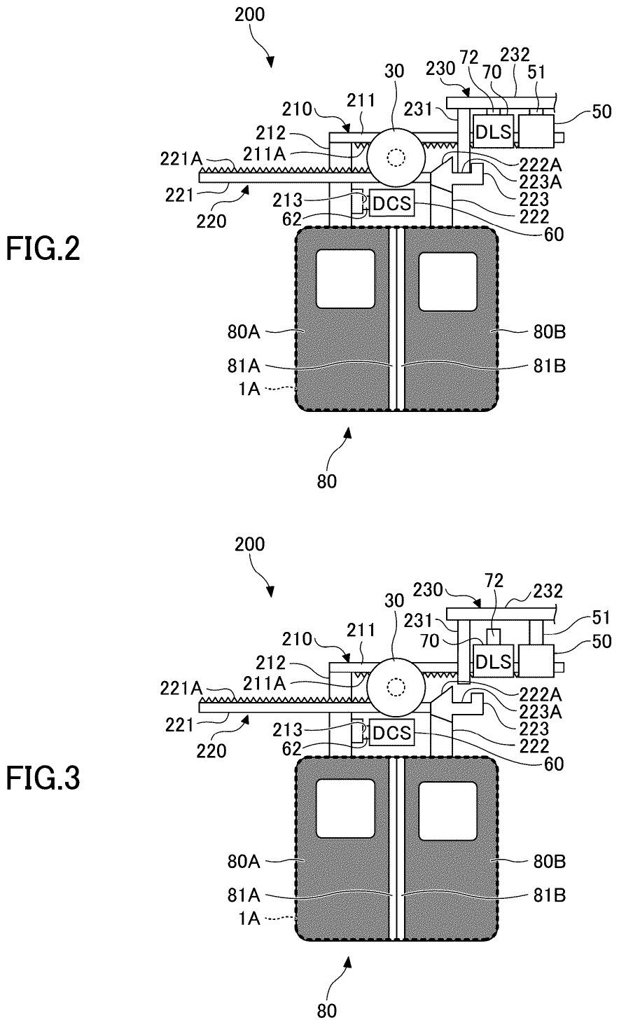

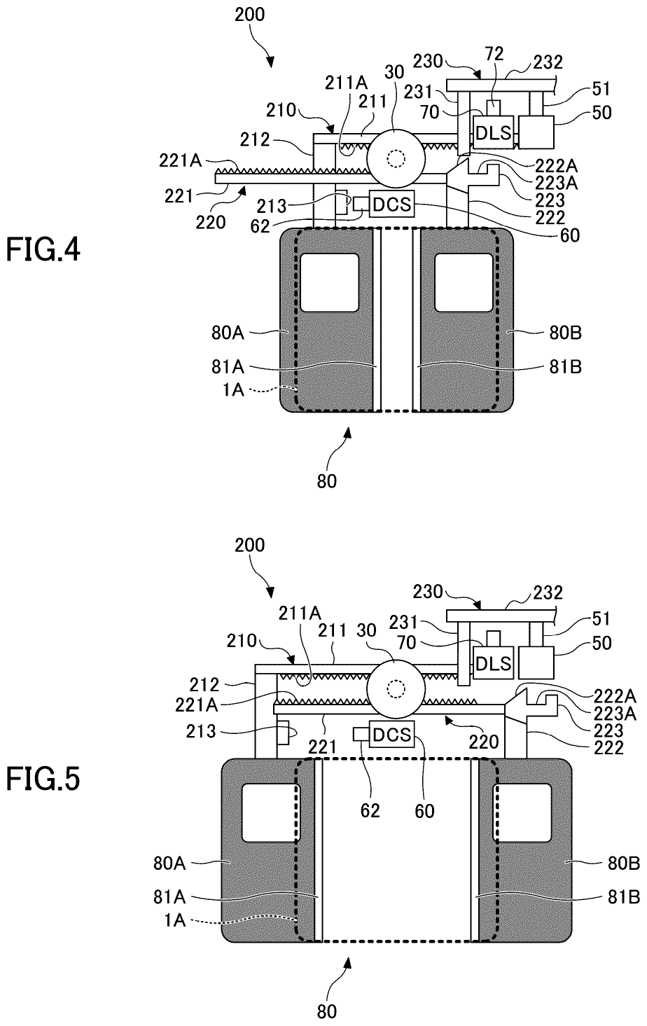

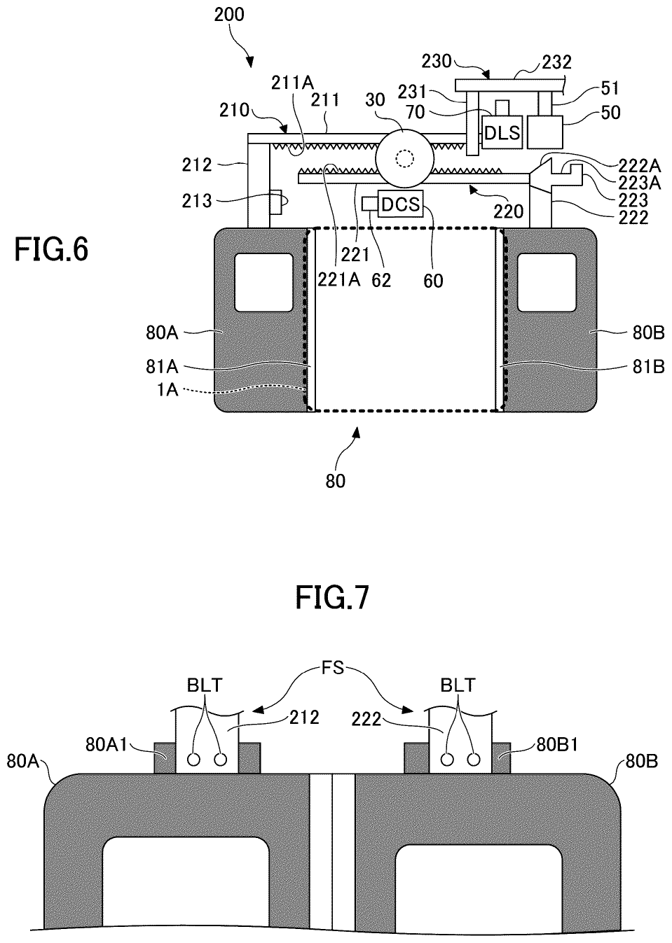

FIG. 1 is a block diagram illustrating a configuration example associated with the opening and closing of the door 80 in the train carriage 1. FIGS. 2 to 6 are diagrams schematically illustrating an example of an arrangement structure of the door 80 and a door drive mechanism 200 in the train carriage 1. Specifically, FIG. 2 is a diagram schematically illustrating the door 80 and the door drive mechanism 200 in a fully closed and locked state of the door 80. FIG. 3 is a diagram schematically illustrating the door 80 and the door drive mechanism 200 in a fully closed and unlocked state. FIG. 4 is a diagram schematically illustrating the door 80 and the door drive mechanism 200, during opening (immediately after the door 80 starts opening) or closing (just before the door 80 finishes closing). FIG. 5 is a diagram schematically illustrating the door 80 and the door drive mechanism 200, during opening (just before the door 80 finishes opening) or closing (immediately after the door 80 starts closing). FIG. 6 is a diagram schematically illustrating the door 80 in the fully opened state of the door drive mechanism 200.

The train carriage 1 may be a single-car carriage that is composed of one car, or may be a plural-car carriage that is composed of a plurality of cars that are linked together.

As illustrated in FIGS. 1 to 6, the train carriage 1 includes a host device 10, a motor 30, an encoder 31, current sensors 32, a diagnostic sensor 40, a locking device 50, a door close switch (DCS) 60, a door lock switch (DLS) 70, and the door 80. The train carriage 1 also includes a door controller 100, a power source 150, an input contactor 151, and the door drive mechanism 200.

The host device 10 includes one or more carriage controllers 12, one or more door-operating devices 14, and a transmission device 16.

The carriage controller 12 performs a control for the operation of the train carriage 1. For example, when train carriages 1 have a plurality of cars, one carriage controller 12 is provided in each of a driver's room in a first car and a conductor's room in a last car. Also, for example, when the train carriage has one car, carriage controllers 12 are respectively provided in a front-side driver's room and a rear-side conductor's room of the train carriage 1 (carriage).

A function of the carriage controller 12 is implemented by any hardware, any combination of hardware and software, or the like. The carriage controller 12 is mainly implemented, for example, by a computer that includes a central processing unit (CPU), a memory device, an auxiliary storage device, and an input-and-output interface device for interfacing with an external device. The memory device is, for example, a static random access memory (SRAM). The auxiliary storage device includes, for example, an electrically erasable programmable read only memory (EEPROM) or a flash memory. The interface device includes, for example, a communication interface for coupling to a communication line that is inside the train carriage 1, or a communication line outside the train carriage 1. The interface device may also include an external interface for coupling an external recording medium. With this arrangement, for example, in a manufacturing process, a worker can install a program or various data, from the external recording medium to the auxiliary storage device or the like of the carriage controller 12, where the program or the various data is to be used to perform a process associated with the operational control of the train carriage 1. The program and various data used to perform the process associated with the operational control of the train carriage 1 may be downloaded from the outside of the train carriage 1, via the communication interface. Further, the interface device may include different types of interface devices, in light of the types of communication lines to be coupled.

When the train carriage 1 is stopped at a station or the like, the carriage controller 12 outputs a stop signal indicating that the train carriage 1 is stopped, to the door controller 100. The carriage controller 12 outputs, to the door controller 100, an open command to open the door 80, or a close command to close the door 80, where the open command or the close command from the door-operating device 14 is input to the door controller 100.

Lines 13 via which an interlock signal is transmitted are coupled to the carriage controller 12. The lines 13 are coupled, at respective ends, to the carriage controller 12, and the DCS 60 and the DLS 70 are provided on the respective lines 13. If at least one of the DCS 60 or the DLS 70 is in an off state, the lines 13 are in a non-conductive state. In this case, the interlock signal that is input to the carriage controller 12 becomes at a L (Low) level. In contrast, if both the DCS 60 and the DLS 70 are in an on state, the lines 13 are in a conductive state. In this case, the interlock signal that is input to the carriage controller 12 becomes at a H (High) level. When the interlock signal is at the H level, the carriage controller 12 determines that the train carriage 1 is in a movable state. With this arrangement, when the interlock signal changes from the L level to the H level, the train carriage 1 can travel.

The door-operating device 14 is used for a crew (for example, a conductor) of the train carriage 1 to open or close the door 80. The door-operating device 14 includes an opening switch 14A and a closing switch 14B. For example, when the opening switch 14A is operated during shutdown of the train carriage 1, the door-operating device 14 outputs the open command to change the interlock signal from the L level to the H level, to the carriage controller 12. Further, for example, when the closing switch 14B is operated during shutdown of the train carriage 1, the door-operating device 14 outputs the close command to change the interlock signal from the H level to the L level, to the carriage controller 12.

The transmission device 16 relays a signal between the door controller 100, which is provided for doors 80 of the train carriage 1, and the carriage controller 12.

Specifically, the transmission device 16 may receive various signals (input signals SDR) that are transmitted from the carriage controller 12 to one or more door controllers 100, and may then transmit the signals to a portion or all of the target door controllers 100. The transmission device 16 may also receive various signals (output signals SD) to be transmitted from respective door controllers 100 to the carriage controller 12, to transmit the signals to the carriage controller 12.

The motor 30 drives the door 80 to open and close. The motor 30 is, for example, a rotary machine that is driven by three-phase alternating current (AC) drive power. The motor 30 may be a linear motor that is driven by three-phase AC drive power. The motor 30 may be a direct current (DC) motor that is driven by direct current.

The encoder 31 detects a rotational position or a displacement position of the motor 30. For example, when the motor 30 is a rotary machine, the encoder 31 detects the rotational position (rotation angle) of a rotary shaft of the motor 30. The encoder 31 detects, for example, the rotational position (rotation angle) of the rotary shaft of the motor 30 that is rotating one time, and detects revolutions per minute (rpm) for the motor 30. The encoder 31 outputs a detection signal including information relating to the rotational position of the rotary shaft of the motor 30, and the detection signal is input to the door controller 100. With this arrangement, the door controller 100 can acquire position information of the door 80 with respect to an open-and-closed direction, based on the signal from the encoder 31. That is, information included in the signal from the encoder 31 corresponds to the position information of the door 80.

Current sensors 32 detect currents of the three-phase AC drive power that is supplied to the motor 30 by the door controller 100. The current sensors 32 include current sensors 32A and 32B that detect currents each of which flows via any two power lines among three power lines of a U-phase, a V-phase, and a W-phase, where the three power lines couple the door controller 100 to the motor 30. For example, the current sensor 32A detects a current for the U-phase power line, and the current sensor 32B detects a current for the W-phase power line. The current sensors 32 may include a current sensor that detects a current for the remaining one power line. For example, as illustrated in FIG. 1, the current sensors 32 may be incorporated in the door controller 100, or may be provided outside the door controller 100. Detection signals from the current sensors 32 (current sensors 32A and 32B) are each input to a normal controller 110 and a backup controller 120 as described below.

The diagnostic sensor 40 acquires data related to the operation of the door 80, and the data is used to diagnose (hereinafter referred to as “abnormality diagnosis”) an abnormality in the door 80. The diagnostic sensor 40 includes, for example, a sound sensor (microphone) to measure sound of the door 80 during opening and/or closing, or a vibration sensor or the like to measure vibration of the door 80 during opening and/or closing.

The diagnostic sensor 40 may not be omitted.

The locking device 50 locks and unlocks the door 80. The locking device 50 includes, for example, a pin 51 and coils 52 and 53, and is implemented by bidirectional self-holding solenoids. Each of the coils 52 and 53 is coupled to the door controller 100.

In the locking device 50, when the coil 52 is energized by the door controller 100, the pin 51 is protruded from a housing of the locking device 50. As a result, a lock pin 230 described below moves in an unlock direction, and thus the door 80 is unlocked. In addition, because the locking device 50 is a self-holding type, the locking device 50 maintains a state where the pin 51 protrudes from a housing of the locking device 50 even after the energization of the coil 52 is released. With this arrangement, the door 80 can be maintained in an unlocked state.

In the locking device 50, when the coil 53 is energized by the door controller 100, the pin 51 is drawn into the housing of the locking device 50. As a result, a lock pin 230 described below moves in a lock direction, and thus the door 80 is locked. In addition, because the locking device 50 is the self-holding type, the locking device 50 maintains a state where the pin 51 is drawn into the housing of the locking device 50 even after the energization of the coil 53 is released. With this arrangement, the door 80 can be maintained in a locked state.

The DCS 60 detects whether the door 80 of the train carriage 1 is open or closed. Specifically, the DCS 60 detects a fully closed state in which the door 80 of the train carriage 1 is fully closed. The DCS 60 is implemented, for example, by a limit switch that is pressed by the door 80 that operates when the door 80 moves to a fully closed position.

The DCS 60 includes fixed contacts 61A1 and 61A2, fixed contacts 61B1 and 61B2, and a movable contact 62.

The fixed contacts 61A1 and 61A2 are respectively arranged at ends of two lines into which the line 13 is divided. In the following description, the fixed contacts 61A1 and 61A2 may be referred to as an “A-contact pair” for the DCS 60, for convenience.

The fixed contacts 61B1 and 61B2 are arranged at ends of two lines into which a line 101 is divided, where the two lines are coupled to the door controller 100. With this arrangement, the door controller 100 can identify an on-off state of the DCS 60, in accordance with a H-level signal and a L-level signal, where the H-level signal indicates a conductive state of the fixed contacts 61B1 and 61B2, and the H-level signal indicates a non-conductive state of the fixed contacts 61B1 and 61B2. In the following description, the fixed contacts 61B1 and 61B2 may be referred to as a “B-contact pair” for the DCS 60, for convenience.

When the movable contact 62 moves along an axial direction (vertical direction in FIG. 1), one pair among the A-contact pair (fixed contacts 61A1 and 61A2) and the B-contact pair (fixed contacts 61B1 and 61B2) of the DCS 60 becomes conductive. In the DCS 60, in a state where no external force acts, the movable contact 62 makes the B-contact pair conductive. That is, the DCS 60 is held in a state where the B-contact pair is on and the A-contact pair is off. In contrast, in the DCS 60, as described below, when the movable contact 62 is pressed by the operation of the door 80, the A-contact pair is turned on in a state where the A-contact pair is conducted by the movable contact 62 while the B-contact pair is turned off. Then, in accordance with the operation of the door 80, the movable contact 62 returns to a state of not being pressed. In this case, the DCS 60 returns to a state where the B-contact pair, which is conducted by the movable contact 62, is turned on and the A-contact pair is turned off.

For example, the door controller 100 can identify an on-off state of the B-contact pair for the DCS 60, based on a signal that is input to the door controller 100 via the line 101. Further, for example, the door controller 100 can identify an on-off state of the A-contact pair for the DCS 60, by inverting the signal that is input to the door controller 100 via the line 101.

The DLS 70 detects whether the door 80 is locked. Specifically, the DLS 70 detects the locked state of the door 80. For example, when the lock pin 230 for the door 80 moves to a locking position, the DLS 70 is implemented by a limit switch that is pressed by the operation of the lock pin 230.

The DLS 70 includes fixed contacts 71A1 and 71A2, fixed contacts 71B1 and 71B2, and a movable contact 72.

The fixed contacts 71A1 and 71A2 are respectively arranged at ends of two lines into which the line 13 is divided. In the following description, the fixed contacts 71A1 and 71A2 may be referred to as an “A-contact pair” for the DLS 70, for convenience.

The fixed contacts 71B1 and 71B2 are arranged at ends of two lines into which a line 102 is divided, where the two lines are coupled to the door controller 100. With this arrangement, the door controller 100 can identify an on-off-state of the DLS 70, in accordance with a H-level signal and a L-level signal, where the H-level signal indicates a conductive state of the fixed contacts 71B1 and 71B2, and the H-level signal indicates a non-conductive state of the fixed contacts 71B1 and 71B2. In the following description, the fixed contacts 71B1 and 71B2 may be referred to as a “B-contact pair” for the DLS 70, for convenience.

When the movable contact 72 moves along an axial direction (vertical direction in FIG. 1), one pair among the A-contact pair (fixed contacts 71A1 and 71A2) and the B-contact pair (fixed contacts 71B1 and 71B2) of the DLS 70 becomes conductive. In the DLS 70, in a state where no external force acts, the movable contact 72 makes the B-contact pair conductive. That is, the DLS 70 is held in a state where the B-contact pair is on and the A-contact pair is off. In contrast, in the DLS 70, when the movable contact 72 is pressed by the operation of the lock pin 230, the A-contact pair is turned on, and the B-contact pair is turned off. Then, in the DLS 70, when the movable contact 72 returns to a state of not being pressed by the operation of the lock pin 230, the B-contact pair is turned on, and the A-contact pair is turned off.

For example, the door controller 100 can identify an on-off state of the B-contact pair for the DLS 70, based on a signal that is input to the door controller 100 via the line 102. Further, for example, the door controller 100 can identify an on-off state of the A-contact pair for the DLS 70, by inverting the signal that is input to the door controller 100 via the line 102.

When the door 80 is fully closed and locked, both the A-contact pair for the DCS 60 and the A-contact pair for the DLS 70 are turned on, and thus the line 13 becomes conductive. As a result, the interlock signal becomes at the H level.

The door 80 is a double sliding door that is provided at an opening (hereinafter referred to as a “door opening”) in each of a left side surface and a right side surface of a car body of the train carriage 1. The door 80 includes door panels 80A and 80B.

With use of the door panels 80A and 80B, the door 80 (door opening of the car body) is opened or closed using the door drive mechanism 200, in accordance with power from the motor 30. Specifically, the door panels 80A and 80B can close or open the door opening of the car body, by moving the door panels 80A and 80B in opposite directions, i.e., front-and-back directions, when viewed from a middle portion of the door opening of the car body in a front-and-back directions.

In the fully closed state of the door 80, door end rubbers 81A and 81B are respectively provided at portions of the door panels 80A and 80B that can be in contact with each other. Each of the door end rubbers 81A and 81B is provided in an area from an upper end, to a lower end, of a contact portion of a corresponding door panel with the other door panel, among the door panels 80A and 80B.

The door controller 100 performs a control relating to the opening and closing of the door 80. The door controller 100 is provided for each unit of multiple doors 80 that are provided in the train carriage 1.

A function of the door controller 100 is implemented by any hardware, any combination of hardware and software, or the like. The door controller 100 is mainly implemented, for example, by a computer that includes a central processing unit (CPU), a memory device, an auxiliary storage device, and an interface device for input and output with one or more external devices. The memory device is, for example, an SRAM. The auxiliary storage device includes, for example, an EEPROM, or a flash memory. The interface device includes, for example, a communication interface for coupling a communication line that is inside the train carriage 1. The interface device may also include an external interface for coupling an external recording medium. With this arrangement, for example, in a manufacturing process, an operator can install a program or various data relating to a control process for the door 80, from an external recording medium to be stored in an auxiliary storage device or the like of the door controller 100. The program or various data relating to the control process for the door 80 may be downloaded from the host device 10 through a communication interface. Further, the interface device may include different types of interface devices, in light of types of communication lines to be coupled.

The door controller 100 includes the normal controller 110, the backup controller 120, a switching circuit 130, and a switching circuit 140.

The normal controller 110 performs a control for opening and closing the door 80. The normal controller 110 includes a power circuit 111, a communication unit 112, an input signal detector 113, a sequence unit 114, a motor controller 115, a motor drive unit 116, and a locking-and-unlocking drive unit 117.

The power circuit 111 functions as a drive power source that is used for various devices of the normal controller 110. With use of power of a relatively high voltage (for example, 100 V) that is supplied to the door controller 100 by the power source 150, the power circuit 111 generates power of a relatively low voltage (for example, 5 V or lower) for driving the devices of the normal controller 110.

The communication unit 112 performs a two-way communication with the transmission device 16 that is outside the door controller 100.

The input signal detector 113 detects various signals that are input from the outside of the door controller 100.

The input signal detector 113 may perform various processes based on one or more detected signals.

For example, upon detecting a predetermined signal among input signals, the input signal detector 113 transmits the predetermined signal to the sequence unit 114 or the motor controller 115. That is, the input signal detector 113 extracts (selects) the signal necessary for the control of the sequence unit 114 or the motor controller 115, from multiple types of input signals, and then transmits the signal to the sequence unit 114 or the motor controller 115. With this arrangement, as described below, the sequence unit 114 and the motor controller 115 can appropriately perform a sequence control and a drive control for the motor 30, respectively, based on one or more signals that are input from the input signal detector 113.

The sequence unit 114 performs the sequence control for opening and closing the door 80, based on the signal that is input from the input signal detector 113. Specifically, the sequence unit 114 performs the sequence control for opening and closing the door 80, in accordance with a stop signal, an open command, a close command, and the like that are from the carriage controller 12. The sequence unit 114 also performs the sequence control for opening and closing the door 80, while identifying an open-and-close state of the door 80, a position of the door 80 in the open-and-closed direction, and the presence or absence of the locking of the door 80, and the like, by using signals from the encoder 31, the DCS 60, and the DLS 70, and the like.

The motor controller 115 performs a drive control of the motor 30 such that the door 80 is opened or closed in accordance with a control command that relates to the opening or closing of the door 80 and is from the sequence unit 114. For example, the motor controller 115 generates a pulse width modulation (PWM) signal for driving the motor 30, based on a speed command and a propulsion command of the motor 30 that are input from the sequence unit 114, and then outputs the PWM signal to the motor drive unit 116. Specifically, the motor controller 115 may generate the PWM signal that matches the speed command and the propulsion command, while identifying the current in the motor 30, the rotational position of the rotary shaft of the motor 30, and the like, by using one or more detection signals at the encoder 31, the current sensors 32, and the like, where the detection signals are input from the input signal detector 113.

The motor drive unit 116 generates and outputs three-phase AC power for driving the motor 30, by using the DC power that is input from the power source 150. The motor drive unit 116 includes, for example, an inverter circuit that converts DC into three-phase AC having a predetermined voltage and a predetermined frequency. In the motor drive unit 116, two input-side DC power lines are coupled to the power source 150 through the input contactor 151, and three output-side power lines are coupled to the motor 30 through the switching circuit 130.

The locking-and-unlocking drive unit 117 energizes the coil 52 or 53 of the locking device 50, in accordance with a lock command or an unlock command that is input from the sequence unit 114, and then drives the locking device 50 (pin 51) in a lock direction or an unlock direction of the door 80. In the locking-and-unlocking drive unit 117, input-side DC power lines consisting of a positive line and a negative line are coupled to the power source 150 through the input contactor 151. Also, in the locking-and-unlocking drive unit 117, one among two sets of output-side DC power lines, which consist of a positive line and a negative line, is coupled to the coil 52 through the switching circuit 140, and the other set is coupled to the coil 53 through the switching circuit 140. For example, the locking-and-unlocking drive unit 117 includes a semiconductor switch capable of switching power lines between conduction and non-conduction, where the power lines include a power line between the input-side DC power lines and one set of the output-side DC power lines, and include a power line between the input-side DC power lines and the other set of the output-side DC power lines. The locking-and-unlocking drive unit 117 switches the semiconductor switch on and off. Specifically, in response to receiving the unlock command from the sequence unit 114, the locking-and-unlocking drive unit 117 may shift a power line state between the input-side DC power lines and any one set of the output-side DC power lines, to the conductive state, to thereby energize the coil 52 of the locking device 50 through the switching circuit 140. In addition, in response to receiving the lock command from the sequence unit 114, the locking-and-unlocking drive unit 117 may shift a power line state between the input-side DC power lines and the other set of output-side DC power lines, to the conductive state, to thereby energize the coil 53 of the locking device 50 through the switching circuit 140.

The backup controller 120 is configured to be able to perform the control for opening and closing the door 80, and functions as a backup of the normal controller 110. With this arrangement, in the door controller 100, the backup controller 120 is provided in addition to the normal controller 110, and redundancy of a control system related to the opening and closing of the door 80 is enabled. Specifically, when an abnormality occurs in the normal controller 110, the backup controller 120 performs the control for opening and closing the door 80, instead of using the normal controller 110.

The backup controller 120 includes the same components as those of the normal controller 110. Specifically, the backup controller 120 includes a power circuit 121, a communication unit 122, an input signal detector 123, a sequence unit 124, a motor controller 125, a motor drive unit 126, and a locking-and-unlocking drive unit 127.

The power circuit 121 has the same hardware configuration and function as described in the power circuit 111 of the normal controller 110. The communication unit 122 has the same hardware configuration and function as described in the communication unit 112 of the normal controller 110. The input signal detector 123 has the same hardware configuration and function as described in the input signal detector 113 of the normal controller 110. Further, the sequence unit 124 has the same hardware configuration and function as described in the sequence unit 114 of the normal controller 110. The motor controller 125 has the same hardware configuration and function as described in the motor controller 115 of the normal controller 110. The motor drive unit 126 has the same hardware configuration and function as described in the motor drive unit 116 of the normal controller 110. The locking-and-unlocking drive unit 127 has the same hardware configuration and function as described in the locking-and-unlocking drive unit 117 of the normal controller 110. In light of the above, detailed description thereof is omitted.

The switching circuit 130 switches between a state in which the motor drive unit 116 and the motor 30 are electrically coupled to each other and a state in which the motor drive unit 126 and the motor 30 are electrically coupled to each other. Specifically, three-phase AC output power lines of each of the motor drive unit 116 and the motor drive unit 126 are coupled to an input side of the switching circuit 130, and three-phase AC input power lines that extend from the motor 30 are coupled to an output side of the switching circuit 130. The switching circuit 130 switches between a state in which the output power lines of the motor drive unit 116 and input power lines of the motor 30 conduct and a state in which the output power lines of the motor drive unit 126 and the input power lines of the motor 30 conduct.

The switching circuit 130 maintains a state in which the motor drive unit 116 and the motor 30 are electrically coupled to each other, when the normal controller 110 performs the control for opening and closing the door 80. Also, when the abnormality occurs in the normal controller 110, and then the backup controller 120 performs the control for opening and closing the door 80, the switching circuit 130 switches to a connection state in which the motor drive unit 126 and the motor 30 are electrically coupled to each other.

The switching circuit 140 switches between a state in which the locking-and-unlocking drive unit 117 and the locking device 50 (coil 52 or 53) are coupled to each other and a state in which the locking-and-unlocking drive unit 127 and the locking device 50 (coil 52 or 53) are coupled to each other. Specifically, two sets of output power lines, for each of the locking-and-unlocking drive unit 117 and the locking-and-unlocking drive unit 127, are coupled to an input side of the switching circuit 140, and two sets of input power lines that extend from the locking device 50 (coil 52 and 53) are coupled to an output side of the switching circuit 150. Further, the switching circuit 140 switches between a state in which the two sets of output power lines for the locking-and-unlocking drive unit 117 are coupled to the two sets of input power lines of the locking device 50, and a state in which the two sets of output power lines of the locking-and-unlocking drive unit 127 are coupled to the two sets of input power lines of the locking device 50.

When the normal controller 110 performs the control for opening and closing the door 80, the switching circuit 140 maintains a state in which the locking-and-unlocking drive unit 117 and the locking device 50 (coil 52 or 53) are electrically coupled to each other. Also, when an abnormality occurs in the normal controller 110, and then the backup controller 120 shifts a control state to a state in which the opening and closing of the door 80 are controlled, the switching circuit 140 switches to a state in which the locking-and-unlocking drive unit 127 and the locking device 50 (coil 52 or 53) are electrically coupled to each other.

The power source 150 supplies DC power of a predetermined voltage (for example, 100 volts) to various devices of the train carriage 1, and the various devices include the motor 30, the locking device 50, and the door controller 100. The power source 150 includes, for example, a battery and an auxiliary power source device. The battery supplies DC power to the various devices of the train carriage 1, in a state where a pantograph of the train carriage 1 is not coupled to an overhead line. The auxiliary power source device generates DC power, based on power that is supplied via the overhead line from the pantograph, in a state where the pantograph of the train carriage 1 is coupled to the overhead line. Then, the auxiliary power source device supplies the DC power to the various devices of the train carriage 1.

The input contactor 151 is provided in a power circuit between the power source 150 and various devices that include the door controller 100. The input contactor 151 switches between supply of power to the various devices of the train carriage 1 and interruption of the supply, by opening and closing the power circuit. The input contactor 151 is closed, for example, in accordance with a predetermined operation, such as power-up that is enabled in a driver's room of the train carriage 1. With this arrangement, power is supplied to various devices of the train carriage 1, including the door controller 100, and thus the train carriage 1 is activated. In addition, the input contactor 151 is opened, for example, in accordance with a predetermined operation such as power-down that is enabled in the driver's room of the train carriage 1. With this arrangement, supply of power to various devices of the train carriage 1 including the door controller 100 is stopped (interrupted), and thus the train carriage 1 is stopped.

The door drive mechanism 200 transmits the power of the motor 30 to the door 80 to open or close the door 80. The door drive mechanism 200 implements the locked state or the unlocked state of the door 80, in accordance with the movement of the locking device 50 (pin 51).

The door drive mechanism 200 includes racks 210 and 220 and the lock pin 230.

The rack 210 is attached to an upper end portion of the door panel 80A. The rack 210 includes a rack portion 211 and a connection portion 212.

The rack portion 211 is a member that extends in the front-and-back direction of the train carriage 1. A rack gear 211A is provided on a lower surface of the rack portion 211. The rack portion 211 is disposed above the door opening of the train carriage 1 (car body) to be slightly above the rotary shaft of the motor 30 whose rotary shaft is disposed along a width direction (left-right direction) of the train carriage 1. With this arrangement, a pinion gear, which is disposed coaxially with the rotary shaft of the motor 30, can be engaged with the rack gear 211A on the lower surface of the rack portion 211. Thus, the rack portion 211 can be moved in the front-and-back direction of the train carriage 1, in accordance with the rotation of the motor 30.

The connection portion 212 couples the door panel 80A and the rack portion 211. The connection portion 212 is provided so as to extend upward from an upper end portion of the door panel 80A, and the rack portion 211 is coupled to an upper end portion of the connection portion 212. With this arrangement, the door panel 80A moves in the front-and-back direction of the train carriage 1, in conjunction with the movement of the rack portion 211 that corresponds to the rotation of the motor 30, and the opening-and-closing operation of the door 80 can be realized. In this case, the movement of the door panel 80A in the front-and-back direction is guided by a slide rail (hereinafter referred to as a “door rail”).

A DCS contact 213 is provided with the connection portion 212.

As illustrated in FIGS. 2 and 3, when the door panels 80A and 80B transition to the fully closed state, the DCS contact 213 comes into contact with the movable contact 62 of the DCS 60, and thus the movable contact 62 is pressed. With this arrangement, the movable contact is pushed to turn the DCS 60 on. In contrast, as illustrated in FIGS. 4 to 6, when the door panels 80A and 80B transition to a state other than the fully closed state of the door panel 80A, the DCS contact 213 transitions to a state in which the DCS contact 213 does not contact the movable contact 62 of the DCS 60, and thus the DCS 60 is turned off.

The rack 220 is attached to an upper end portion of the door panel 80B. The rack 220 includes a rack portion 221, the connection portion 212, and the lock-pin contact portion 223.

The rack portion 221 is a member that extends in the front-back direction of the train carriage 1. A rack gear 221A is provided on an upper surface of the rack portion 221. The rack portion 221 is disposed above the door opening of the train carriage 1 to be slightly below the rotary shaft of the motor 30. With this arrangement, the pinion gear disposed coaxially with the rotary shaft of the motor 30 can be engaged with the rack gear 211A on the upper surface of the rack portion 221. Thus, the rack portion 221 can be moved in the front-and-back direction of the train carriage 1, in accordance with the rotation of the motor 30.

The connection portion 222 couples the door panel 80B and the rack portion 221. The connection portion 222 is provided so as to extend upward from the upper end portion of the door panel 80B, and the rack portion 221 is coupled to the upper end portion of the connection portion 222. With this arrangement, the door panel 80B moves in the front-and-back direction of the train carriage 1, in conjunction with the movement of the rack portion 221 that corresponds to the rotation of the motor 30, and the opening-and-closing operation of the door 80 can be realized. In this case, the movement of the door panel 80B in the front-and-back direction is guided by a slide rail (door rail).

In this description, the rack gear 211A is engaged with the pinion gear that is disposed coaxially with the motor 30, when viewed from above. The rack gear 221A is engaged with the pinion gear, when viewed from below. Thus, the racks 210 and 220 can be moved in an opposite direction, in accordance with the rotation of the motor 30. Therefore, the opening and the closing of the two door panels 80A and 80B can be realized using one motor 30.

An inclined portion 222A that slopes down toward a middle side of the door opening, with respect to the front-and-back direction of the train carriage 1, is provided at the upper end portion of the connection portion 222.

In the locked state of the door 80, the lock pin 230 is in contact with the lock-pin contact portion 223. The lock-pin contact portion 223 is provided so as to protrude from an end side of the connection portion 222, where the end side is opposite a direction in which the rack portion 221 extends. A lock hole 223A is provided in the lock-pin contact portion 223.

The lock hole 223A is a recess that is provided at the upper surface of the lock-pin contact portion 223. When the door 80 is locked, a lower end of the lock pin 230 (a pin 231 described below) is inserted in the lock hole 223A.

The lock pin 230 is provided above the lock-pin contact portion 223 of the rack 220. The lock pin 230 includes the pin 231 and a locking-device contact portion 232.

The pin 231 is provided to extend in the vertical direction.

The locking-device contact portion 232 is attached to an upper end portion of the pin 231, and is provided so as to extend from a connection with the pin 231 in a horizontal direction. Specifically, the locking-device contact portion 232 is provided to extend in a direction opposite the direction in which the door opening extends in the front-and-back direction of the train carriage 1. The locking device 50 is fixedly disposed below the locking-device contact portion 232, and the upper end portion of the pin 51 of the locking device 50 contacts the lower surface of the locking-device contact portion 232. With this arrangement, when the pin 51 of the locking device 50 is protruded upward, the locking-device contact portion 232 moves upward, and when the pin 51 of the locking device 50 is drawn in a downward direction, the locking-device contact portion 232 moves downward by the weight of the lock pin 230.

As illustrated in FIGS. 3 to 6, in a state in which the pin 51 of the locking device 50 is protruded, the lower end of the pin 231 that is coupled to the locking-device contact portion 232 is positioned higher than the inclined portion 222A of the rack 220, and thus the pin 231 does not engage with the lock hole 223A. With this arrangement, the rack 220 can move without being influenced by the arrangement of the lock pin 230, and thus the door 80 (the door panels 80A and 80B) becomes in a state of being movable in the open and closed directions.

In contrast, as illustrated in FIG. 2, in a state where the pin 51 of the locking device 50 is drawn, the lower end of the pin 231 is positioned lower than the inclined portion 222A of the rack 220. Further, in the fully closed state of the door 80, the pin 231 is positioned closer to the lock-pin contact portion 223 than the inclined portion 222A in the front-and-back direction of the train carriage 1. With this arrangement, when the pin 51 of the locking device 50 is drawn in the fully closed state of the door 80, the locking-device contact portion 232 moves downward, and thus the pin 231 engages with the lock hole 223A (protruding portion) of the rack 220. As a result, the movement of the rack 220 is restricted, and the rotation of the pinion gear that engages with the rack gear of the rack 220 is restricted. Thus, the movement of the rack 210 having the rack gear 211A that engages with the pinion gear is restricted. Therefore, the movement of the door panels 80A and 80B that are respectively coupled to the racks 210 and 220 is restricted, and the locked state of the door panels 80A and 80B is held.

The door panels 80A and 80B are configured to be separate from the door drive mechanism 200 (racks 210 and 220), and the door panels 80A and 80B are fastened (coupled) to the door drive mechanism 200 by respective fastening structures FS.

For example, as illustrated in FIG. 7, one fastening structure FS includes a fastening plates 80A1 and bolts BLT, and the other fastening structure FS includes a fastening plate 80B1 and bolts BLT.

The fastening plate 80A1 is a flat plate that is provided so as to extend upward from an upper end of the door panel 80A. For example, the fastening plate 80A1 is coupled to a main body of the door panel 80A by welding or the like. The fastening plate 80A1 has two fastening holes that correspond to the respective bolts BLT. These fastening holes are provided through the fastening plate 80A1 in the width direction (left-right direction) of the train carriage 1.

In a state where the rack 210 and the door panel 80A are appropriately coupled to each other, two fastening holes are provided in a lower portion of the connection portion 212 of the rack 210, so as to be approximately aligned with the respective two fastening holes of the fastening plate 80A1 in the front-and-back direction and the vertical direction. The two fastening holes of the connection portion 212 are provided so as to pass through the connection portion 212 in the width direction (left-right direction) of the train carriage 1. With this arrangement, the fastening plate 80A1 and the connection portion 212 overlap each other, such that a set of fastening holes of the fastening plate 80A1 is aligned with a set of fastening holes of the connection portion 212 in the front-and-back direction and the vertical direction, then each bolt BLT is inserted through corresponding different fastening holes, and finally is fastened by a nut on a backside of the bolt BLT.

The fastening plate 80B1 is a flat plate that is provided so as to extend upward from an upper end of the door panel 80B. For example, the fastening plate 80B1 is coupled to a main body of the door panel 80B by welding or the like. The fastening plate 80B1 has two fastening holes that correspond to the respective bolts BLT. These fastening holes are provided through the fastening plate 80B1 in the width direction (left-right direction) of the train carriage 1.

In a state where the rack 220 and the door panel 80B are appropriately coupled to each other, two fastening holes are provided in a lower portion of the connection portion 222 of the rack 220, so as to be approximately aligned with the respective two fastening holes of the fastening plate 80B1 in the front-and-back direction and the vertical direction. The two fastening holes of the connection portion 222 are provided so as to pass through the connection portion 222 in the width direction (left-right direction) of the train carriage 1. With this arrangement, the fastening plate 80B1 and the connection portion 222 overlap each other, such that a set of fastening holes of the fastening plate 80B1 is aligned with a set of fastening holes of the connection portion 222 in the front-and-back direction and the vertical direction, then each bolt BLT is inserted through corresponding different fastening holes, and finally is fastened by a nut on a backside of the bolt BLT.

### Abnormality Diagnosis for Door

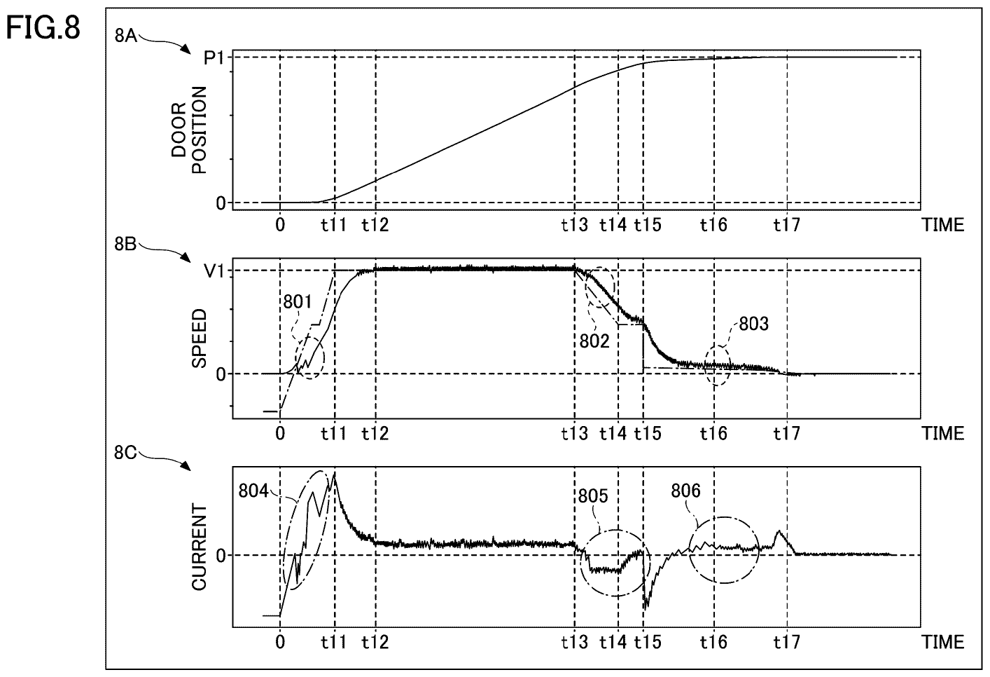

Hereinafter, the diagnosing (hereinafter simply referred to as “abnormality diagnosis”) of the abnormality in the door 80 will be described with reference to FIGS. 8 to 13. In this description, a subject that performs abnormality diagnosis for the door 80 will be described as a diagnostic system SYS for convenience.

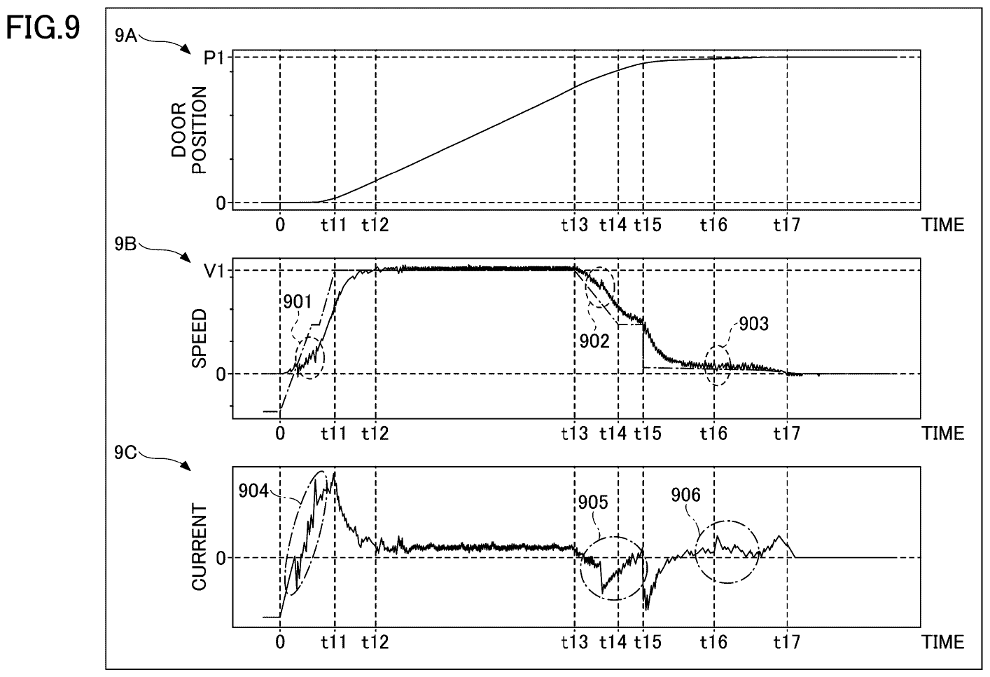

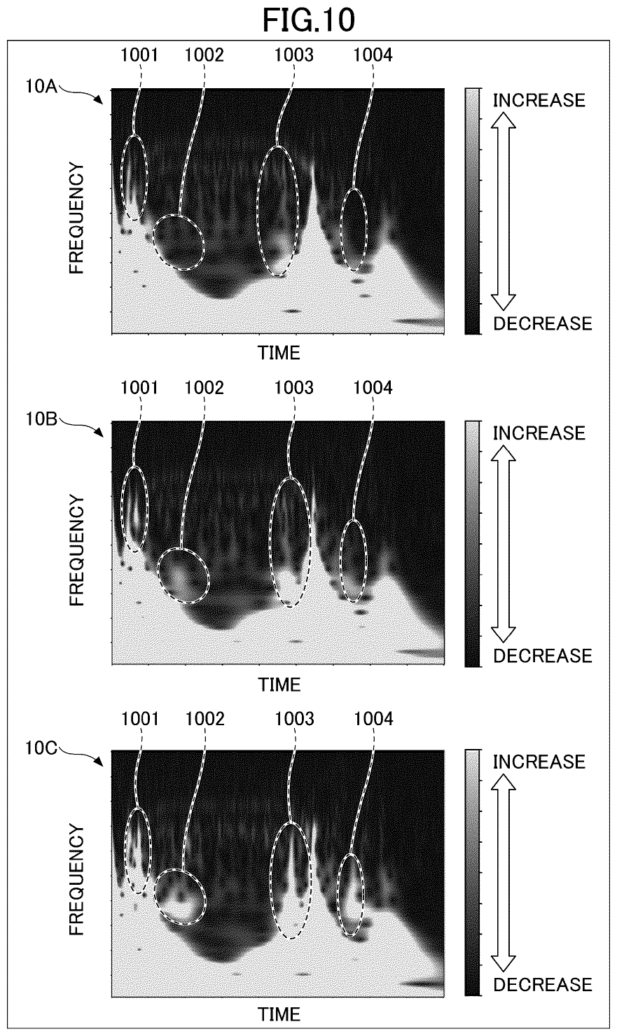

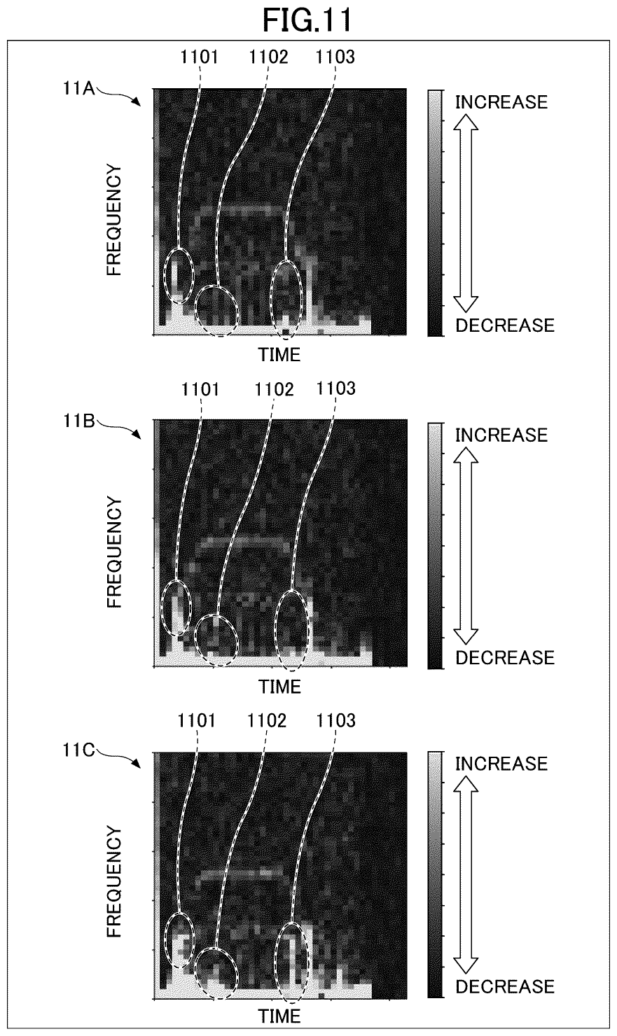

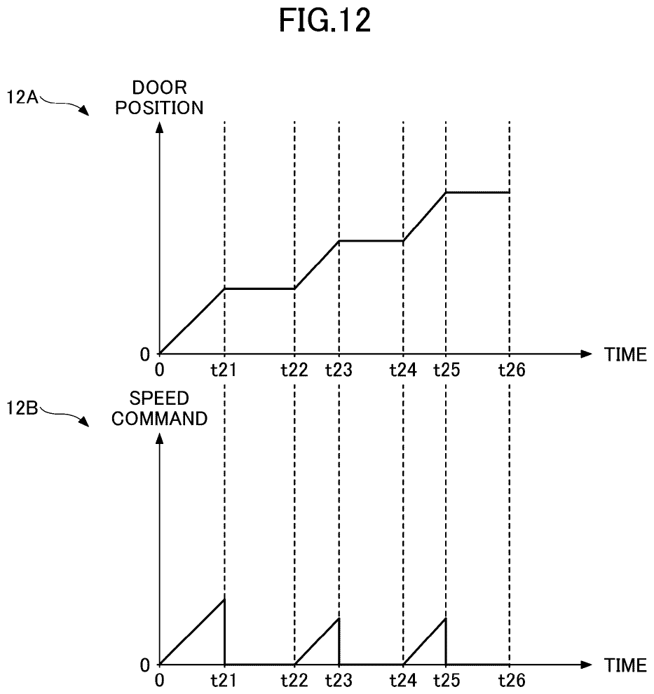

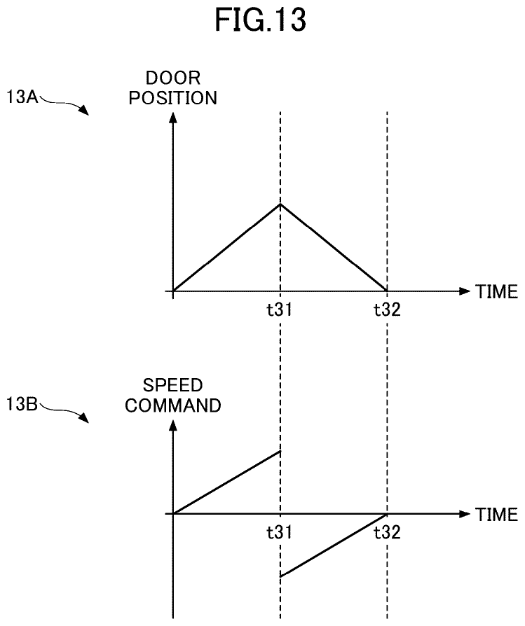

FIG. 8 is a diagram illustrating an example of temporal changes in a position and a speed of the door 80, and the current in the motor 30 during opening of the door 80, in a case where the fastening structures FS to fasten the respective door panels 80A and 80B to the door drive mechanism 200 are under a normal condition. Specifically, FIG. 8 includes graphs 8A to 8C showing an example of the temporal changes in the position and the speed of the door 80, and the current in the motor 30, during the opening of the door 80, in the case where the fastening structures FS are under the normal condition. FIG. 9 is a diagram illustrating an example of temporal changes in the position and the speed of the door 80, and the current in the motor 30, during opening of the door 80, in a case where one or more fastening structures FS to fasten the respective door panels 80A and 80B to the door drive mechanism 200 are under an abnormal condition. Specifically, FIG. 9 includes graphs 9A to 9C showing an example of the temporal changes in the position and the speed of the door 80, and the current in the motor 30, during the opening of the door 80, in the case where the one or more fastening structures FS are under the abnormal condition. FIG. 10 is a diagram illustrating a first example of a frequency analysis result that is derived from time series data of the current during the opening of the door 80. Specifically, FIG. 10 includes graphs 10A to 10C respectively showing frequency analysis data under three conditions, i.e., a normal condition of the fastening structures FS, a lower abnormality level of one or more fastening structures FS, and a higher abnormality level of one or more fastening structures FS, where the frequency analysis data is obtained by performing continuous wavelet transform (CWT) on the time series data of the current during the opening of the door 80. FIG. 11 is a diagram illustrating a second example of the frequency analysis result that is derived from the time series data of the current during the opening of the door 80. Specifically, FIG. 11 includes graphs 11A to 11C respectively showing frequency analysis data under three conditions, i.e., a normal condition of the fastening structures FS, a lower abnormality level of one or more fastening structures FS, and a higher abnormality level of one or more fastening structures FS, where the frequency analysis data is obtained by performing short time Fourier transform (STFT) on the time series data of the current during the opening of the door 80. FIG. 12 is a diagram for describing a first example of the diagnostic mode in which the door 80 moves. Specifically, FIG. 12 includes graphs 12A and 12B respectively showing temporal changes in the position of the door 80 and the speed command for the door 80, in the first example of the diagnostic mode. FIG. 13 is a diagram for describing a second example of the diagnostic mode in which the door 80 moves. Specifically, FIG. 13 includes graphs labeled 13A and 13B respectively showing temporal changes in the position of the door 80 and the speed command for the door 80, in the second example of the diagnostic mode.

On graphs 8B and 9B, the changes in the speed command value for the door 80 are indicated by the one-dot chain line. In FIGS. 10 and 11, the magnitude of the frequency component is expressed by grayscale or monochrome.

The diagnostic system SYS acquires data (hereinafter referred to as “diagnostic data”) related to the operation of the door 80 during the opening and/or closing, and diagnoses an abnormality in the door 80, based on the acquired diagnostic data.

The diagnostic data related to the operation of the door 80 includes, for example, data (measurement data) of a measurement value, and data of a command value. The measurement value and command value are related to the operation of the door 80.

The abnormality diagnosis includes, for example, diagnosing of the presence or absence of an abnormality, or diagnosing or the like of the extent to which the abnormality occurs. The abnormality diagnosis may also include diagnosing of the presence or absence of a sign of the abnormality.

The abnormality diagnosis for the door 80 includes, for example, abnormality diagnosis for one or more fastening structures FS to fasten the door 80. The abnormality in the fastening structure FS includes, for example, an abnormal state in which the fastening structure FS is loosened due to deterioration. In addition, the abnormality in the fastening structure FS may include, for example, an abnormal state in which a relatively great impact hits the door 80 or the door drive mechanism 200 for some reason, so that the fastening structure FS is loosened or is partially damaged.

Hereinafter, abnormality diagnosis for the fastening structure FS in the diagnostic system SYS will be described.

The door controller 100 (each of the motor controller 115 or the motor controller 125) has the normal mode and the diagnostic mode, as control modes that relate to each of opening and closing of the door 80.

The normal mode is the control mode relating to each of the opening and closing of the door 80, and is used when a passenger of the train carriage 1 gets on and off through the door opening. In the normal mode, the door controller 100 operates (travels) the door 80 at a constant speed V1, except for (i) a period during which the door 80 accelerates after the door 80 starts opening or closing, and (ii) a period during which the door 80 decelerates before the door stops opening or closing.

For example, the diagnostic system SYS acquires diagnostic data related to the operation of the door 80, in an operating mode. The operating mode is, for example, a normal mode in which at least one of opening or closing of the door 80 is performed. With this arrangement, for example, when the train carriage 1 stops at a certain station, diagnostic data used to diagnose an abnormality in the fastening structures FS can be acquired. Thus, the diagnostic system SYS can more easily diagnose the abnormality in the door 80. In addition, the diagnostic system SYS can provide an increased number of timings at each of which the diagnostic data is to be acquired. As a result, the abnormality, or a sign of the abnormality, in the fastening structures FS can be detected earlier.

The data related to the operation of the door 80 includes, for example, data of the speed of the door 80 or data of the current in the motor 30. The data related to the operation of the door 80 may include a type of data (for example, data of sound, or vibration, of the door 80) that can be acquired by the diagnostic sensor 40.

The diagnostic data acquired by the diagnostic system SYS includes data that is acquired in at least one of an acceleration period whose beginning is a point at which the door 80 starts moving, and a deceleration period whose end is a point at which the door 80 stops the operation. More specifically, the diagnostic data acquired by the diagnostic system SYS includes data that is acquired in a period in which a command value (speed command value), indicating the speed of the door 80, generated within the door controller 100 changes with time. This is because, in comparison to a normal state of the fastening structure FS, data related to the acceleration or deceleration of the door 80 is greatly influenced by inertia of each of the door panels 80A and 80B that is caused by the abnormality in the fastening structure FS. For example, when the abnormality in the fastening structure FS occurs, rattling of a corresponding door panel, among the door panels 80A and 80B occurs with respect to the door drive mechanism 200. As a result, in a process to transmit power of the motor 30 to the door panels 80A and 80B through the door drive mechanism 200, the effect of the inertia of the door panels 80A and 80B may be increased.

The diagnostic data may include only data relating to a period in which the door 80 is in at least one of an accelerated state or a decelerated state, or may include data relating to a period in which the door 80 is in a state other than the accelerated state and the decelerated state. When the diagnostic data includes the data relating to the period in which the door 80 is in the state other than the accelerated state and the decelerated state, the diagnostic system SYS may diagnose the abnormality in the door 80 by directly using the diagnostic data. Alternatively, the diagnostic system SYS may diagnose the abnormality in the door 80 by using processed data that is obtained by extracting, from diagnostic data, only data relating to periods in which the door 80 is in an accelerated state and the decelerated state.

For example, as expressed on each of the graphs 8B and 9B, in a period (hereinafter referred to as the “acceleration period”) from time 0 to time t11, a speed command value for the door 80 increases from a negative value to a positive value that exceeds zero, where the negative value allows for a state in which the door panels 80A and 80B are pressed against each other in the closing direction. With this arrangement, the speed (measurement value) of the door 80 increases in a period from time 0 to time t12 after time t11, in accordance with an increasing speed command value.

As expressed on each of the graphs 8B and 9B, when there are abnormalities in one or more fastening structures FS, the speed (measurement value) of the door 80 increases at the beginning of the acceleration period (see boxes 801 and 901), while vibration of a relatively short cycle is caused by the effect of the inertia of the door panels 80A and 80B, unlike a normal case. With this arrangement, the diagnostic system SYS can determine whether the speed of the door 80 is influenced by the inertia of the door panels 80A and 80B, based on time series data (diagnostic data) of measurement values indicative of the speed of the door 80, where the time series data is obtained at the beginning of the acceleration period. That is, the time series data is obtained immediately after the door 80 starts moving. Then, the diagnostic system SYS can diagnose the abnormality in one or more fastening structures FS.

In addition, as expressed on each of the graphs 8C and 9C (see boxes 804 and 904), when there are abnormalities in one or more fastening structures FS, a q-axis current in the motor 30 increases in the acceleration period in which vibration of a relatively short cycle occurs due to the effect of the inertia of the door panels 80A and 80B, unlike the normal case. With this arrangement, the diagnostic system SYS can determine whether the q-axis current in the motor 30 is influenced by the inertia of the door panels 80A panels and 80B, based on the time series data (diagnostic data) of each of the measurement value, and the command value, for the current in the door 80 that flows in the acceleration period, and then can diagnose the abnormality in one or more fastening structures FS.

As shown in each of the graphs 8B and 9B, the speed command value for the door 80 decreases approximately linearly in a period (hereinafter referred to as a “first deceleration period”) from time t13 to time t14, after a certain period from time t12 to time t13. With this arrangement, the speed (measurement value) of the door 80 decreases in the period after time t13, in accordance with a decreasing speed command value.

As shown in each of the graphs 8B and 9B (see boxes 802 and 902), when there are abnormalities in one or more fastening structures FS, a relatively great disturbance partially occurs in the speed (measurement value) of the door 80 in the first deceleration period, due to the effect of the inertia of the door panels 80A and 80B, unlike a normal case. With this arrangement, the diagnostic system SYS can determine whether the speed of the door 80 is influenced by the inertia of the door panels 80A and 80B, based on time series data (diagnostic data) of a measurement value of the speed of the door 80, where the time series data is obtained in the first deceleration period. Then, the diagnostic system SYS can diagnose the abnormality in one or more fastening structures FS.

As shown on graphs 8C and 9C, when there are abnormalities in one or more fastening structures FS, the q-axis current in the motor 30 decreases so as to change relatively significantly in a negative region (regeneration region) (see boxes 805 and 905). In this case, the q-axis current in the motor 30 lags the q-axis current in the normal case, due to the effect of inertia of one or more among the door panels 80A and 80B in a first deceleration period. For this reason, the diagnostic system SYS can determine whether the q-axis current in the motor 30 is influenced by the inertia of at least one of the door panel 80A or 80B, based on the time series data (diagnostic data) of each of a measurement value, and a command value, of the current in the door 80 in the first deceleration period, and then can diagnose the abnormality of one or more fastening structures FS.

As shown on graphs 8B and 9B, the speed command value for the door 80 decreases in a stepwise manner after a certain period from time t14 to time 15. Then, after a certain period from time t15 to time t16, the speed command value for the door 80 decreases very slowly in a period from time t16 to time t17 (hereinafter referred to as a “second deceleration period”), and finally reaches 0 (zero) at time t17. In such a case, the speed (measurement value) of the door 80 decreases in the period from time t16 to time t17, and then reaches 0 (zero) in accordance with the decrease in the speed command value.

As shown on graphs 8B and 9B, when there are abnormalities in one or more fastening structures FS, the speed (measurement value) of the door 80 varies greatly at the beginning of the second deceleration period, compared to the normal case (see boxes 803 and 903). In such a manner, the diagnostic system SYS can determine whether the speed of the door 80 is influenced by at least one of the door panel 80A or 80B, based on the time series data (diagnostic data) of a measurement value of the speed of the door 80 at the beginning of the second deceleration period, and thus diagnose the abnormality in one or more fastening structures FS.

In addition, as shown on graphs 8C and 9C, when there are abnormalities in one or more fastening structure FS, the q-axis current in the motor 30 changes relatively greatly in the second deceleration period, compared to the normal case (boxes 806 and 906). Thus, the diagnostic system SYS can determine whether the q-axis current in the motor 30 is influenced by at least one of the door panel 80A or 80B, based on the time series data (diagnostic data) of each of a measurement value and a command value of the q-axis current in the second deceleration period. Then, the diagnostic system SYS can diagnose the abnormality in one or more fastening structure FS.

For example, the diagnostic system SYS directly or indirectly compares diagnostic data with reference data, where the diagnostic data is related to the operation of the door 80 that is being opened or closed, and the diagnostic data includes data that is obtained during both the acceleration period and the deceleration period. The reference data is the same type of data as the type of data related to the operation of the door 80 in a case where the fastening structures FS are in a normal state.

The reference data is, for example, data that is related to the operation of the door 80 and is acquired in the case where the fastening structures FS are in the normal state. The reference data may also be data that is generated by performing statistical processing or the like on a data group, and the data group is related to the operation of the door 80 and is acquired in the case where the fastening structures FS are in the normal state. The data related to the operation of the door 80 to be used as the reference data is acquired, for example, at a timing at which the train carriage 1 starts operating, or a timing that is immediately after maintenance of the train carriage 1 is performed.

Specifically, with use of any known method such as pattern matching, the diagnostic system SYS may directly compare the diagnostic data with the reference data to diagnose the abnormality in one or more fastening structures FS. In addition, the diagnostic system SYS may diagnose the abnormality in one or more fastening structures FS, by indirectly comparing the diagnostic data with the reference data, where a threshold, such as an upper limit or a lower limit, is defined for each of the acceleration period or the deceleration period, and is generated in consideration of the reference data.

With use of a learned model in which a supervised data set, including a data group related to the operation of the door 80, is learned with supervised learning, the diagnostic system SYS may diagnose the abnormality in one or more fastening structures FS, based on diagnostic data, where the data group is obtained under the normal condition of the fastening structures FS. With this arrangement, the diagnostic system SYS can indirectly compare the diagnostic data related to the operation of the door 80, with data related to the operation of the door 80 in the case where the fastening structures FS are under the normal condition. Subsequently, the diagnostic system SYS can diagnose the abnormality diagnosis in one or more fastening structures FS.

The trained model may be generated in the diagnostic system SYS, or may be generated outside the diagnostic system SYS. For example, the trained model is generated by the diagnostic apparatus 2 described below.

The diagnostic system SYS may perform frequency analysis on the acquired diagnostic data, to diagnose an abnormality in one or more fastening structures FS, based on data (hereinafter “frequency analysis data for diagnosis”) of a result of the frequency analysis.

In the frequency analysis, the diagnostic data may be analyzed so that frequency components may be analyzed over an entirety of the acceleration period and/or the deceleration period. Alternatively, the frequency analysis (e.g., time-frequency analysis) may be performed on the diagnostic data to analyze changes in the frequency component within a given time period. In the first analysis case, for example, fast Fourier transform (FFT) is used, and in the second analysis case, for example, continuous wavelet transform (CWT) or short-time Fourier transform (STFT) is used.

For example, as illustrated in FIG. 10, in domains 1001 to 1004 that are defined by the time and frequency axes for frequency analysis data that is obtained by continuous wavelet transformation, a range of frequency components that is higher under an abnormal condition of one or more fastening structures FS than that under a normal condition tends to be increased. In addition, in the domains 1001 to 1004, a range of higher frequency components tends to increase in accordance with an increasing abnormality level.

With this arrangement, the diagnostic system SYS can diagnose the abnormality in one or more fastening structures FS, based on the frequency components in the domains 1001 to 1004 that are defined by the time and frequency axes for the frequency analysis data that is obtained by continuous wavelet transformation. For example, based on magnitudes of the frequency components in the domains 1001 to 1004, the diagnostic system SYS diagnoses the presence or absence of an abnormality, and a degree of abnormality, in one or more fastening structures FS.

Also, as illustrated in FIG. 11, in domains 1101 to 1103 defined by the time and frequency axes for frequency analysis data that is obtained by short-time Fourier transformation, a range of frequency components that is higher under an abnormal condition of one or more fastening structures FS than that under a normal condition tends to be increased. In addition, in the domains 1101 to 1103, a range of higher frequency components tends to increase in accordance with an increasing abnormality level.

With this arrangement, the diagnostic system SYS can diagnose the abnormality in one or more fastening structures FS, based on the frequency components in the domains 1101 to 1103 that are defined by the time and frequency axes for the frequency analysis data that is obtained by short-time Fourier transformation. For example, based on magnitudes of the frequency components in the domains 1101 to 1103, the diagnostic system SYS diagnoses the presence or absence of an abnormality, and a degree of the abnormality, in one or more fastening structures FS.

In the continuous wavelet transformation, a frequency domain is logarithmically divided into a plurality of domains. With this approach, with use of frequency analysis data obtained by the continuous wavelet transformation, the diagnostic system SYS can more easily detect changes in the frequency component due to the effect of the inertia of the door panels 80A and 80B, over a relatively low frequency domain. In contrast, in the short-time Fourier transformation, the frequency domain is divided into a number of equal intervals. With this approach, by using the short-time Fourier transformation, the diagnostic system SYS can relatively easily detect the changes in the frequency due to the effect of the inertia of the door panels 80A and 80B, over the entire frequency domain. In view of the approaches, the diagnostic system SYS may diagnose the abnormality in one or more fastening structure FS, based on both the frequency analysis data obtained by the continuous wavelet transformation and the frequency analysis data obtained by the short-time Fourier transformation.

For example, the diagnostic system SYS directly or indirectly compares diagnosis-frequency analysis data with data (hereinafter referred to as “reference-frequency analysis data”) indicative of a result of frequency analysis that is performed on the same type of data as data related to the operation of the door 80, where the data related to the operation of the door 80 is obtained in a case where the fastening structures FS are under the normal condition. Then, the diagnostic system SYS diagnoses the abnormality diagnosis in one or more fastening structures FS.

The reference-frequency analysis data is, for example, data indicative of the result of the frequency analysis that is performed on the data related to the operation of the door 80, where the data related to the operation of the door 80 is acquired in the case where the fastening structures FS are under the normal condition. In addition, the reference-frequency analysis data may be obtained by performing statistical processing or the like based on the data indicative of the result of frequency analysis that is performed on each data in a data group that is related to the operation of the door 80, where the data group is acquired under the normal condition of the fastening structures FS. The data related to the operation of the door 80 is acquired under the normal condition of the fastening structures FS, and is used as original data from which the reference-frequency analysis data is derived. The data related to the operation of the door 80 is acquired, for example, at a timing at which the train carriage 1 starts operating, or a timing that is immediately after maintenance of the train carriage 1 is performed.

Specifically, with use of any known technique such as pattern matching, the diagnostic system SYS may perform abnormality diagnosis for one or more fastening structures FS, by directly comparing the diagnosis-frequency analysis data with the reference-frequency analysis data. In addition, with use of a threshold, for a specific frequency domain that is determined from the reference-frequency analysis data, the diagnostic system SYS may diagnose the abnormality in one or more fastening structures FS, by indirectly comparing the diagnosis-frequency analysis data with the reference-frequency analysis data.

With use of a trained model, the diagnostic system SYS may diagnose the abnormality in one or more fastening structures FS, based on the diagnosis-frequency analysis data. The trained model is generated by performing supervised learning with respect to a supervised data set that includes data indicative of the result of the frequency analysis that is performed on a data group that is related to the operation of one or more doors 80. The data group is acquired when the fastening structures FS are under the normal condition. With this arrangement, the diagnostic system SYS can indirectly compare the diagnosis-frequency analysis data with the data indicative of the result of the frequency analysis that is performed on the data related to the operation of one or more doors 80. The data related to the operation of one or more doors 80 is acquired under the normal condition of the fastening structures FS. Then, the diagnostic system SYS can diagnose the abnormality in the fastening structures FS.

As in the above case, the trained model may be generated in the diagnostic system SYS, or may be generated outside the diagnostic system SYS.

As illustrated in FIGS. 10 and 11, the frequency analysis data may be used as image data. In this case, the diagnostic apparatus 2 or the like can generate a trained model relatively easily, based on an existing model (for example, U-net or the like) to which the image data can be input to detect an abnormality in an image by semantic segmentation.

As control modes in which the door 80 opens and closes, the door controller 100 may also use a diagnostic mode, in addition to the above normal mode.

The diagnostic mode is the control mode relating to the opening and closing of the door 80, and the diagnostic mode is used to measure (acquire) data used to perform abnormality diagnosis for the door 80.

For example, as illustrated in FIG. 12, in the diagnostic mode, the door 80 opens while accelerating, and stopping, of the door 80 is performed repeatedly. Specifically, in the diagnostic mode, the speed command value for the door 80 increases approximately linearly from zero in a period from time 0 to time t21, and is maintained at zero in a period from time t21 to time t22. In addition, the speed command value in the diagnostic mode increases approximately linearly from zero in a period from time t22 to time t23, and is maintained at zero in a period from time t23 to time t24. In addition, the speed command value for the door 80 in the diagnostic mode increases approximately linearly from zero in a period from time t24 to time t25, and is maintained at zero in a period from time t25 to time t26. Such a change pattern of the speed command value for the door 80 is repeated until the door 80 reaches a fully opened position. Similarly, in the diagnostic mode, the door 80 may close while the accelerating, and stopping, of the door 80 are performed repeatedly. As a result, diagnostic data related to the operation of the door 80 that opens and/or closes in the diagnostic mode includes time series data that is repeatedly acquired when the door 80 accelerates from the stopping. In such a manner, the diagnostic data is likely to be influenced by the inertia of the door panels 80A and 80B. As a result, with use of the diagnostic data related to the operation of the door 80 that opens and/or closes in the diagnosis mode, the diagnostic system SYS can diagnose the abnormality in the fastening structures FS with higher accuracy.

Also, as illustrated in FIG. 13, the speed command value for the door 80 may greatly change at a certain timing. Specifically, the speed command value for the door 80 increases approximately linearly from zero during a period from time t0 to time t31, so that the door 80 opens while accelerating. Further, the speed command value for the door 80 is inverted to be a negative value at time t31, and an absolute value of the speed command value linearly decreases by changing from a predetermined negative value to zero during a period from time t31 to time t32. In this case, at time t31, the door 80 is closed while decelerating. As a result, the door 80 changes from an opening state to a closing state, and changes from an accelerated state to a decelerated state. The resulting acceleration of the door 80 greatly changes. With this arrangement, the diagnostic data is likely to be influenced by the inertia of the door panels 80A and 80B. As a result, the diagnostic system SYS can perform the abnormality diagnosis for one or more fastening structures FS with higher accuracy, by using the diagnostic data related to the operation of the door 80 that opens and/or closes in the diagnostic mode.

As described above, in this example, the diagnostic system SYS can acquire the diagnostic data related to the operation of the door 80 that accelerates and decelerates during the opening and/or closing operation, and can diagnose the abnormality for one or more fastening structures FS, based on the acquired diagnostic data.

In addition, the diagnostic system SYS may diagnose the presence or absence of a sign of the abnormality in one or more fastening structures FS, based on (i) a history of the diagnostic data related to the operation of the door 80, (ii) the result of the abnormality diagnosis for one or more fastening structures FS, and/or (iii) a history of the diagnostic data, related to the operation of the door 80, that is used for the abnormality diagnosis.

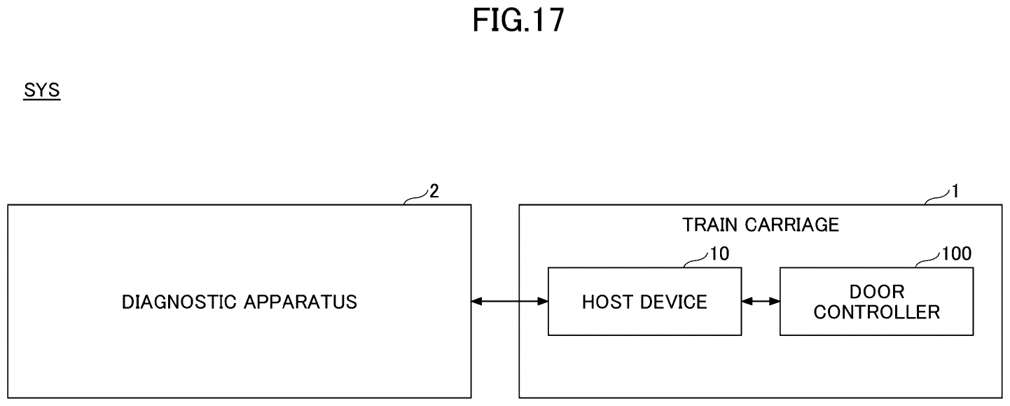

In some cases, the diagnostic system SYS may use big data that includes (i) data indicative of a result of abnormality diagnosis for multiple doors 80 and/or (ii) data used for abnormality diagnosis for multiple doors 80 (see FIGS. 17 to 20). In this case, the diagnostic system SYS may perform machine learning (with unsupervised learning), such as clustering, based on (i) information on the result of the abnormality diagnosis for the multiple doors 80 and/or (ii) the data used for the abnormality diagnosis for the multiple doors 80. Then, the diagnostic system SYS may diagnose the presence or absence of a sign of the abnormality in one or more fastening structures FS of a target door 80.

### First Example Related to Abnormality Diagnosis Process for Door

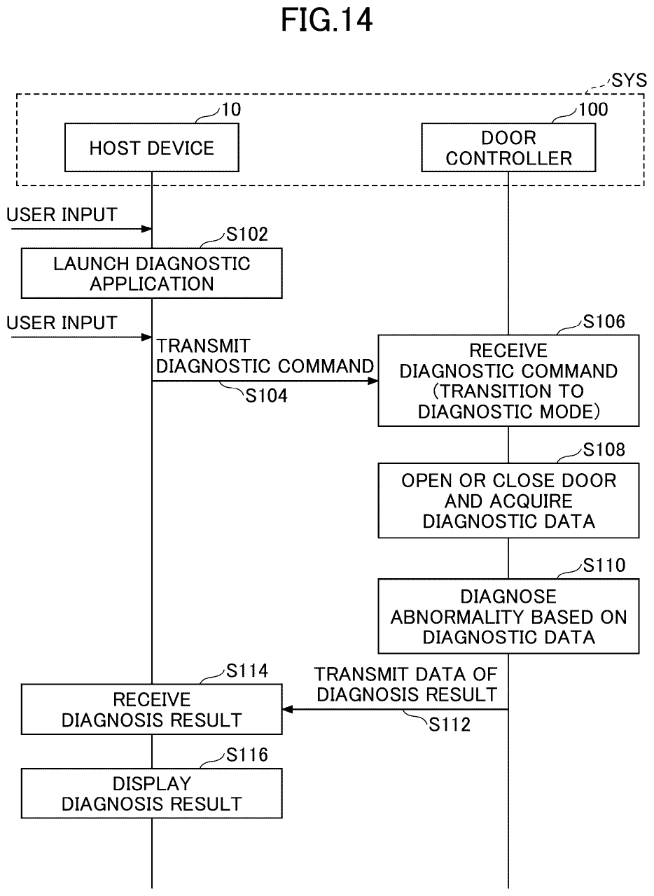

Hereinafter, a first example related to an abnormality diagnosis process for the door 80 will be described with reference to FIG. 14.

FIG. 14 is a sequence diagram illustrating the first example related to the abnormality diagnosis process for the door 80.

In this example, the diagnostic system SYS is provided in the train carriage 1, and includes a host device 10 and a door controller 100.

In this example, a case where in the door controller 100, the normal controller 110, among the normal controller 110 and the backup controller 120, performs the control for the door 80.

As illustrated in FIG. 14, the carriage controller 12 of the host device 10 launches an application program (hereinafter referred to as a “diagnostic application”) related to the abnormality diagnosis for the door 80, in response to receiving a predetermined input from a user, such as a crew in a driver's room or a conductor's room (step S102).

After the process in step S102 is completed, the carriage controller 12 transmits a diagnostic command to the door controller 100 via the transmission device 16, in response to receiving a predetermined input from the user to request to start the abnormality diagnosis for the door 80 (step S104).

The diagnostic command may be used to diagnose an abnormality in all doors 80 of the train carriage 1, or may be used to diagnose the abnormality in only a portion of all the doors 80 of the train carriage 1. In the latter case, the portion of all the doors 80 on which the abnormality diagnosis is to be performed is designated by an input from the user, and the diagnostic command is transmitted to only one or more door controllers 100 that control one or more doors 80 on which the abnormality diagnosis is to be performed.

The input signal detector 113 of the door controller 100 receives the diagnostic command transmitted in the process in step S104, through the communication unit 112, and the motor controller 115 of the door controller 100 shifts a control mode for the door 80 to the diagnostic mode (step S106).

In the normal controller 110, when the process in step S106 is completed, the motor controller 115 and the locking-and-unlocking drive unit 117 open and/or close the door 80 in the diagnostic mode, and the input signal detector 113 measures diagnostic data that is obtained during opening and/or closing of the door 80 (step S108).

When the process in step S108 is completed, the input signal detector 113 performs abnormality diagnosis for the door 80, based on the diagnostic data obtained in step S108 (step S110).

When the process in step S110 is completed, the input signal detector 113 transmits data indicative of a result of the abnormality diagnosis for the door 80 in step S110, to the host device 10 through the communication unit 112 (step S112).

The carriage controller 12 of the host device 10 receives the data transmitted in the process in step S112, through the transmission device 16, where the data indicates the result of the abnormality diagnosis for the door 80 (step S114).

When the process in step S114 is completed, the carriage controller 12 displays the result of the abnormality diagnosis for the door 80, on a display device in a driver's room or a conductor's room, for example (step S116).

With this arrangement, a user such as a crew in a driver's room or a conductor's room can check the result of the abnormality diagnosis for the door 80.

As described above, in this example of the diagnostic system SYS, in response to receiving a request that is input from the user through the host device 10, the door controller 100 acquires data in the diagnostic mode in which the door 80 is opened and/or closed, and subsequently performs abnormality diagnosis for the door 80. Then, in the diagnostic system SYS, the door controller 100 transmits the data that indicates the result of the abnormality diagnosis for the door 80, to the host device 10, and finally provides the result of the abnormality diagnosis for the door 80 to the user, by using the host device 10.

As a result, in the driver's room or the conductor's room, the user can check the result of abnormality diagnosis for all the doors 80 of the train carriage 1. An amount of data that is communicated between the host device 10 and the door controller 100 is relatively smaller than an amount of measurement data that is obtained during opening and/or closing of the door 80, such as diagnostic command data, or data indicative of a result of abnormality diagnosis. For this reason, the amount of data that is communicated between the host device 10 and the door controller 100 can be suppressed to be relatively small.

In proximity to a target door 80 of the train carriage 1 on which abnormality diagnosis is performed, a request for abnormality diagnosis is input from the user, and thus a result of the abnormality diagnosis may be provided to the user. For example, in the door controller 100 provided in a car body that is at a space above the door 80, the door controller 100 may include an input device that receives an input of a user's request for abnormality diagnosis, and may include a notification device (for example, an indicator or the like) that notifies the user of the result of abnormality diagnosis. With this arrangement, for example, a user such as an inspection worker enables abnormality diagnosis for each door 80, and then the user can check a result of the abnormality diagnosis for the door 80, at a place where the door 80 is installed. In addition, because there is no need to communicate data relating to abnormality diagnosis for the door 80, between the host device 10 and the door controller 100, an amount of data that is communicated between the host device 10 and the door controller 100 can be further suppressed.

### Second Example Related to Abnormality Diagnosis Process for Door

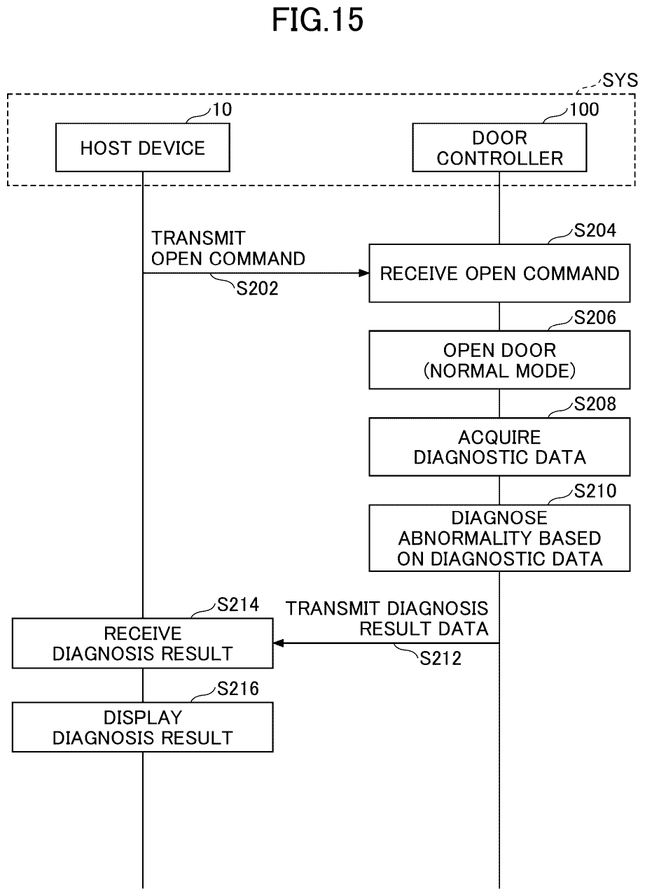

Hereinafter, a second example related to an abnormality diagnosis process for the door 80 will be described with reference to FIG. 15.

FIG. 15 is a sequence diagram illustrating the second example related to the abnormality diagnosis process for the door 80.

In this example, as in the above first example, the diagnostic system SYS is provided in the train carriage 1, and includes the host device 10 and the door controller 100.

Hereinafter, in this example, in the door controller 100, a case where the normal system controller 110, among the normal system controller 110 and the backup system controller 120, controls the door 80.

As illustrated in FIG. 15, the car controller 12 of the host device 10 transmits an open command that is output from the door-operating device 14, to the door controller 100 (step S202).

After the process in step S202, the input signal detector 113 of the door controller 100 receives the open command transmitted in the process in step S202, through the communication unit 112 (step S204).

When the process in step S204 is completed, the normal controller 110 of the door controller 100 opens the door 80 in the normal mode (step S206).

After the process in step S206 is started, the normal controller 110 of the door controller 100 acquires diagnostic data, in accordance with the opening of the door 80 in the normal mode of the door 80 (step S208).

When the process in steps S204 and S206 is completed, the input signal detector 113 diagnoses an abnormality in the door 80, based on the diagnosis date acquired in step S206 (step S210).

Steps S212, S214, and S216 is the same as steps S112, S114, and S116 in FIG. 14 described above, and accordingly description thereof is omitted.

As described above, in this example of the diagnostic system SYS, in response to the open command for the door 80, the door controller 100 can acquire the diagnostic data in the normal mode in which the door 80 is being opened and/or closed. Then, the door controller 100 can perform the diagnosis related to the door 80.

With this arrangement, for example, the diagnostic system SYS can diagnose the abnormality in the door 80, in accordance with a timing at which the train carriage 1 stops at a station. Thus, at an earlier stage (that is, in real time), the diagnostic system SYS can detect the presence or absence, of an abnormality, and a sign of the abnormality, in the door 80.

Also, when a close command for the door 80 is transmitted from the car controller 12 to the door controller 100, the abnormality diagnosis for the door 80 may be performed, as in the process in FIG. 15. In addition, the diagnostic data that is acquired when the door 80 opens and/or closes in the normal mode may be accumulated, and then the abnormality diagnosis for the door 80 may be performed based on the accumulated diagnostic data, at a predetermined timing. In addition, in response to detecting by the door controller 100 that a foreign object enters door 80, the door controller 100 may interrupt the acquiring of the diagnostic data, during the opening or the closing of the door 80. The door controller 100 may not acquire the diagnostic data when a passenger crowd level, for passengers of a target car of multiple cars in the train carriage 1, or for the train carriage 1, is relatively greater than a predetermined criteria, where the door 80 is disposed in the target car. In addition, the door controller 100 may not use the diagnostic data when a foreign object is detected in the door 80 or when a passenger crowd level for passengers is relatively greater than a predetermined criteria. This is because, in view of the fact or the likelihood that if a foreign object is detected in the door 80 or that if a passenger contacts the door 80 when getting on and off the train carriage 1, an action of opening and/or closing the door 80 differs from an expected operating pattern, and thus it is assumed that diagnostic data available for the abnormality diagnosis for one or more fastening mechanisms cannot be acquired.

### Third Example of Abnormality Diagnosis Process for Door

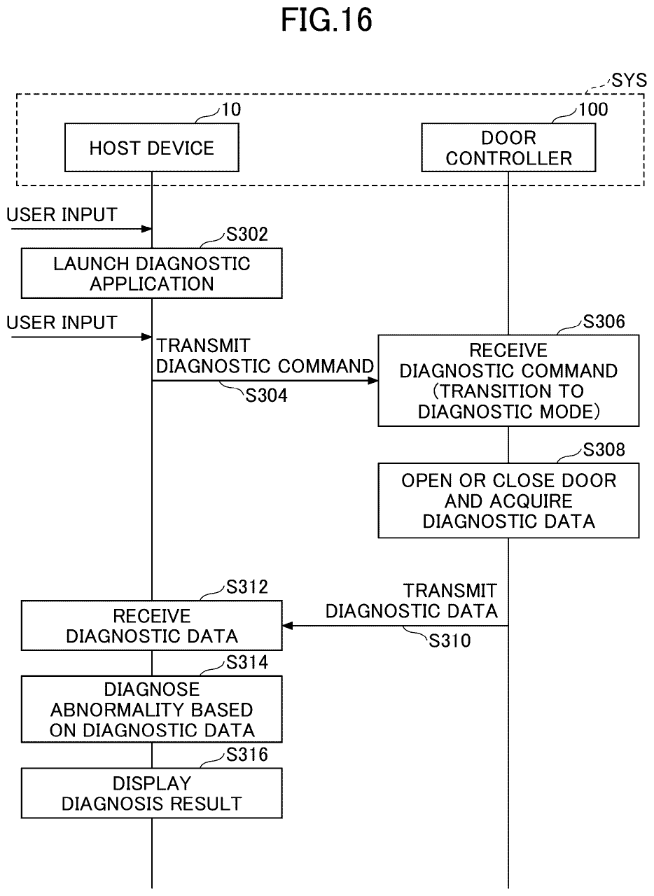

Hereinafter, a third example of the abnormality diagnosis process for the door 80 will be described with reference to FIG. 16.

FIG. 16 is a sequence diagram illustrating the third example of the abnormality diagnosis process for the door 80.

In this example, as in the first example and the second example, the diagnostic system SYS is provided in the train carriage 1, and includes the host device 10 and the door controller 100.

As illustrated in FIG. 16, steps S302, S304, S306, and S308 are the same as steps S102, S104, S106, and S108 in FIG. 14 described above, and accordingly description thereof is omitted.

When the process in step S308 is completed, the input signal detector 113 transmits diagnostic data that is obtained in step S308 to the host device 10, through the communication unit 112 (step S310).

The carriage controller 12 of the host device 10 receives the diagnostic data transmitted from the door controller 100 in step S310, through the transmission device 16 (step S312).

When the process in step S312 is completed, the carriage controller 12 performs abnormality diagnosis for the door 80, based on the diagnostic data received in step S312 (step S314).

When the process in step S314 is completed, as in step S116 in FIG. 14 described above, the carriage controller 12 displays the result of the abnormality diagnosis for the door 80, on the display device in a driver's room or a conductor's room, for example (step S316).

As described above, in this example of the diagnostic system SYS, the door controller 100 acquires the diagnostic data in the diagnostic mode in which the door 80 opens and/or closes, and then transmits the acquired diagnostic data to the host device 10. Subsequently, in the diagnostic system SYS, the host device 10 performs abnormality diagnosis for the door 80, based on the diagnostic data acquired from the door controller 100.

With this arrangement, in this example of the diagnostic system SYS, the host device 10 can sequentially accumulate the diagnostic data, a result of abnormality diagnosis, for all the doors 80 of the train carriage 1. This is because it is easy to secure a sufficiently large storage resource of the host device 10, in comparison to a storage resource of the door controller 100. Thus, the carriage controller 12 can analyze abnormalities of one or more doors 80, based on the diagnostic data or the result of abnormality diagnosis that is acquired in the diagnostic mode in which all the doors 80 of the train carriage 1 open and/or close, where the diagnostic data or the result of the abnormality diagnosis is accumulated in the host device 10. For example, the carriage controller 12 may analyze a history of the diagnostic data or the result of the abnormality diagnosis that is acquired during the opening and/or closing of a specific door 80. In this case, the diagnostic system SYS can predict a deterioration state (sign of abnormality) of the door 80, based on a result of the analysis at the carriage controller 12. As a result, the diagnostic system SYS can diagnose the presence or absence of the abnormality in the door 80, in addition to diagnosing the presence or absence of a given sign of the abnormality in the door 80. Thus, the diagnostic system SYS can more appropriately perform abnormality diagnosis for the door 80.

Also, when diagnostic data in the normal mode is acquired as in the second example (FIG. 15) described above, the diagnostic data is transmitted from the door controller 100 to the host device 10, and thus the host device 10 may diagnose the abnormality in the door 80. In this case, instead of steps S302, S304, S306, and S308 in FIG. 16, steps S202, S204, S206, and S208 in FIG. 15 are adopted.

### Another Example of Diagnostic System

Hereinafter, another example of the diagnostic system SYS will be described with reference to FIG. 17.

FIG. 17 is a diagram illustrating another example of the diagnostic system SYS.

As illustrated in FIG. 17, the diagnostic system SYS includes the train carriage 1 (the host device 10 and the door controller 100) and a diagnostic apparatus 2.

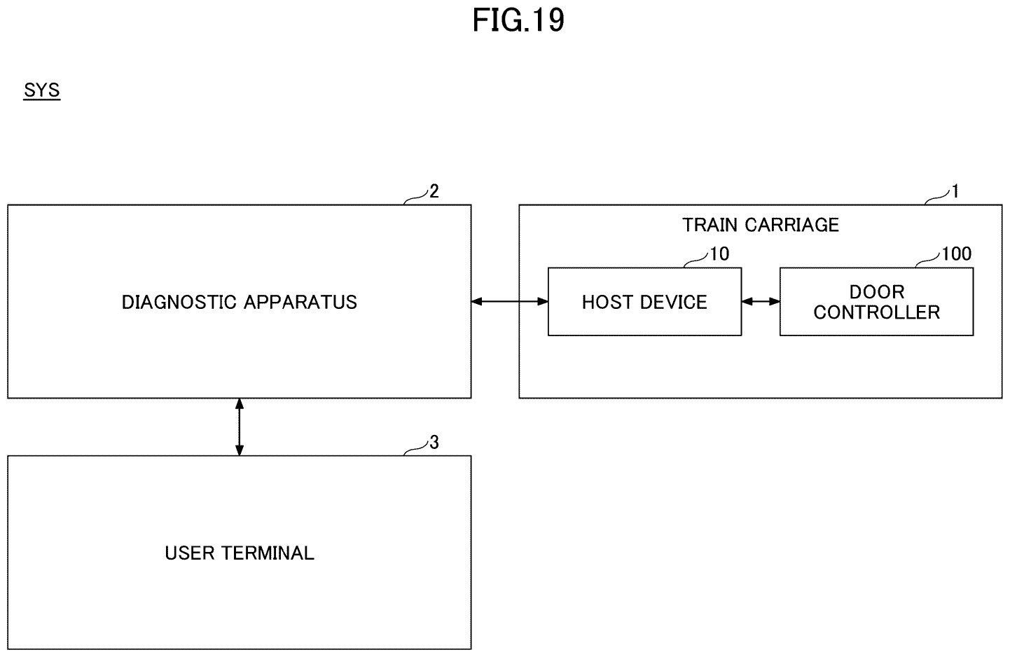

In this example, the train carriage 1 included in the diagnostic system SYS may have one car or a plurality of cars. The same condition may apply to the other example (FIG. 19) described below.

The diagnostic apparatus 2 performs abnormality diagnosis for the door 80 in the train carriage 1.

The diagnostic apparatus 2 is provided outside the train carriage 1. The diagnostic apparatus 2 is communicably coupled to the train carriage 1 through a predetermined communication line.

The predetermined communication line includes, for example, a wide area network (WAN), such as a mobile communication network of which an end point is a base station, or a satellite communication network using one or more communication satellites. In addition, the predetermined communication line may include, for example, a local network that is provided at a station, a rail yard, or the like. The predetermined communication line may include, for example, a short-range communication line based on a predetermined communication standard, such as Bluetooth (registered trademark) or WiFi.

The diagnostic apparatus 2 is a server device having relatively high processing capability. The server device may include an on-premise server, a cloud server, or an edge server. In addition, the diagnostic apparatus 2 may include a terminal device that has relatively lower processing capability compared to a server device. The terminal device may be, for example, a stationary terminal device such as a desktop personal computer (PC), or may be, for example, a portable terminal device (mobile terminal) such as a smartphone, a tablet terminal, or a laptop computer.

A function of the diagnostic apparatus 2 may be implemented by any hardware or any combination of hardware and software. For example, the diagnostic apparatus 2 is mainly implemented by a computer that includes a CPU, a memory device, an auxiliary storage device, and an interface device. The memory device is, for example, an SRAM or a dynamic random access memory (DRAM). The auxiliary storage device is, for example, a hard disc drive (HDD), a solid state drive (SSD), an electrically erasable programmable read-only memory (EEPROM), or a flash memory. The interface device includes, for example, a communication interface for communicating with an external device that includes the train carriage 1 (host device 10). The interface device also includes an external interface for coupling an external recording medium. As a result, a program and various types of data that are used to execute an abnormality diagnosis process for the door 80 can be installed from the recording medium to be stored in the auxiliary storage device or the like of the diagnostic apparatus 2. In addition, the program and various types of data that are used to execute the abnormality diagnosis process for the door 80 may be downloaded from the outside of the diagnostic apparatus 2, through the communication interface. The interface device may include a combination of different types of interface devices, in light of types of communication lines to be coupled. The diagnostic apparatus 2 may further include an input device for receiving various inputs from the user, and may include an output device for outputting information to the user. The input device includes, for example, a mechanical-operation input device, such as a mouse, a keyboard, or a touch panel, that receives a mechanical input from the user. The input device may include, for example, a gesture input device or a voice input device that is capable of receiving a user's input through a gesture or a voice, where a camera, a microphone, or the like is used to detect the gesture or the voice. The output device includes, for example, a display device that visually outputs information, and includes a sound output device that audibly outputs information. The display device includes, for example, a liquid crystal display or an organic electroluminescence (EL) display. The sound output device is, for example, a speaker.

### Fourth Example Related to Abnormality Diagnosis Process for Door

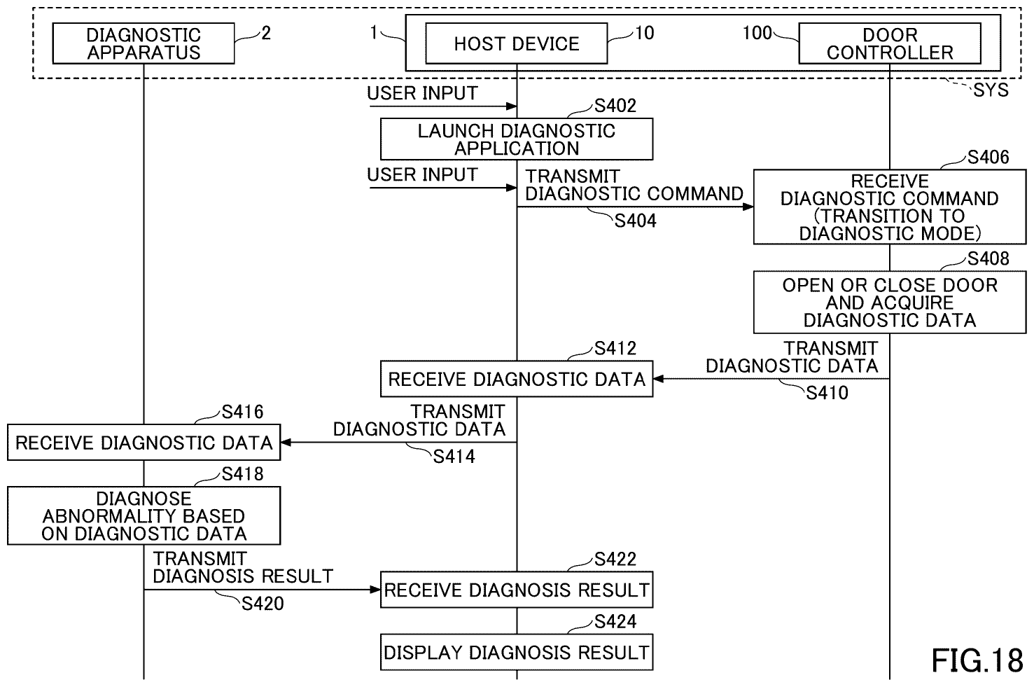

Hereinafter, a fourth example of the abnormality diagnosis process for the door 80 will be described with reference to FIG. 18.

FIG. 18 is a sequence diagram illustrating the fourth example of the abnormality diagnosis process for the door 80.

In this example, the diagnostic system SYS in FIG. 17 described above is used.

As illustrated in FIG. 18, steps S402, S404, S406, S408, S410, and S412 are the same as the steps S302, S304, S306, S308, S310, and S312 illustrated in FIG. 16 above, and accordingly description thereof is omitted.

The carriage controller 12 of the host device 10 transmits diagnostic data that is received in step S412, to the diagnostic apparatus 2 that is situated outside the train carriage 1 (step S414).

The diagnostic apparatus 2 receives the diagnostic data transmitted from the host device 10 of the train carriage 1 in step S414 (step S416).

The diagnostic apparatus 2 performs abnormality diagnosis for the door 80, based on the diagnostic data received in step S416 (step S418).

When the process in step S418 is completed, the diagnostic apparatus 2 transmits a result of the abnormality diagnosis of the door 80, to the host device 10 of the train carriage 1 (step S420).

The carriage controller 12 of the host device 10 receives the result of the abnormality diagnosis for the door 80, where the result is transmitted from the diagnostic apparatus 2 in the process in step S420 (step S422).

When the process in step S422 is completed, the carriage controller 12 displays the result of the abnormality diagnosis for the door 80, on a display device that is in a driver's room or a conductor's room, for example, as in steps S116 and S216 in FIGS. 14 and 16 described above (step S424).

As described above, in this example of the diagnostic system SYS, the diagnostic apparatus 2 that is situated outside the train carriage 1 can perform abnormality diagnosis for the door 80. With this arrangement, a processing load for the train carriage 1 (the host device 10 and the door controller 100), which typically has a relatively small processing resource, can be reduced.

In addition, in this example of the diagnostic system SYS, diagnostic data for each of doors 80 in train carriages 1 having a plurality cars can be acquired, and the diagnostic data can be accumulated for each of the doors 80 on which an abnormality diagnosis process is performed. As a result, the diagnostic apparatus 2 can analyze the abnormality in the doors 80, based on a diagnostic data group that is accumulated during the opening and closing of the doors 80 in the train carriages 1 having the plurality of cars. As a result, the diagnostic apparatus 2 can analyze the abnormality in all of the doors 80, based on a diagnostic data group that is acquired during the opening and closing of the doors 80 in a target train carriage 1, where the diagnostic data group is accumulated in the diagnostic apparatus 2. For example, the diagnostic apparatus 2 may analyze a history of the diagnostic data that is acquired during the opening and closing of a specific door 80. With this arrangement, the diagnostic system SYS can predict a deterioration state (a sign of the abnormality) of the door 80, based on an analysis result that is obtained at the diagnostic apparatus 2, to thereby diagnose the presence or absence of the abnormality of the sign of an abnormality in the door 80, as well as diagnosing the presence or absence of the abnormality in the door 80. In addition, in the diagnostic apparatus 2, machine learning, such as clustering, is adopted based on diagnostic data for doors 80 in all cars in the train carriages 1, and thus one or more abnormal doors 80, or one or more doors 80 having signs of the abnormalities may be extracted from all the doors 80 in train carriages 1. In such a manner, instead of, or in addition of the abnormality diagnosis process, the diagnostic system SYS can perform abnormality diagnosis for one or more doors 80, by adopting machine learning. Thus, the diagnostic system SYS can more appropriately perform the abnormality diagnosis for the door 80.

A diagnostic application may be installed in the diagnostic apparatus 2. The diagnostic apparatus 2 may transmit a diagnostic command to the train carriage 1 (host device 10), in response to receiving a predetermined input from a user at the diagnostic apparatus 2. When the diagnostic system SYS includes train carriages 1 having a plurality of cars, the diagnostic command is transmitted to a specific train carriage 1 that is designated through a predetermined input from the user. Also, as in the second example (FIG. 15), when diagnostic data in the normal mode is acquired, the diagnostic data is transmitted from the door controller 100 to the diagnostic apparatus 2 through the host device 10, and then the diagnostic apparatus 2 may diagnose an abnormality in the door 80. In FIG. 16, steps S202, S204, S206, and S208 are adopted, instead of steps S402, S404, S406, and S408.

### Still Another Example of Diagnostic System

Hereinafter, still another example of the diagnostic system SYS will be described with reference to FIG. 19.

FIG. 19 is a diagram illustrating still another example of the diagnostic system SYS.

As illustrated in FIG. 19, the diagnostic system SYS includes the train carriage 1 (the host device 10 and the door controller 100) and the diagnostic apparatus 2, as in the other example (FIG. 17) described above. The diagnostic system SYS also includes a user terminal 3, unlike the other example (FIG. 17).

The user terminal 3 is a terminal device that the user of the diagnostic system SYS uses.

The user terminal 3 is a terminal device that is used, for example, by an inspector who inspects one or more doors 80, or a person or like that is responsible for maintenance and inspection for the train carriage 1. The user terminal 3 may be, for example, a terminal device that the user for the diagnostic apparatus 2 uses.

The user terminal 3 may be, for example, a stationary terminal device such as a desktop personal computer (PC), or may be, for example, a portable terminal device (mobile terminal) such as a smartphone, a tablet terminal, or a laptop PC.

A function of the user terminal 3 may be implemented by any hardware or any combination of hardware and software. For example, the user terminal 3 is mainly implemented by a computer that includes a CPU, a memory device, an auxiliary storage device, an interface device, an input device, and an output device. The memory device includes, for example, an SRAM or a dynamic random access memory (DRAM). The auxiliary storage device includes, for example, an HDD, an SSD, an EEPROM, a flash memory, or the like. The interface device includes, for example, a communication interface for communicating with an external device that includes the diagnostic apparatus 2. The interface device also includes an external interface for coupling an external recording medium. As a result, a program and various data that are used to execute an abnormality diagnosis process for the door 80 can be installed from the recording medium to be stored in the auxiliary storage device or the like of the user terminal 3. In addition, the program and various data that are used to execute the abnormality diagnosis process for the door 80 may be downloaded from the outside of the user terminal 3, through the communication interface. Further, the interface device may include different types of interface devices, in light of the types of communication lines to be coupled. The input device includes, for example, a mechanical-operation input device such as a mouse, a keyboard, or a touch panel that receives a mechanical input from a user. The input device may include, for example, a gesture input device or a voice input device that is capable of receiving an input by a gesture or voice from a user by a camera, a microphone, or the like. The output device includes, for example, a display device that visually outputs information and a sound output device that audibly outputs information. The display device is, for example, a liquid crystal display or an organic electroluminescence (EL) display. The sound output device includes, for example, a speaker.

### Fifth Example of Abnormality Diagnosis Process for Door

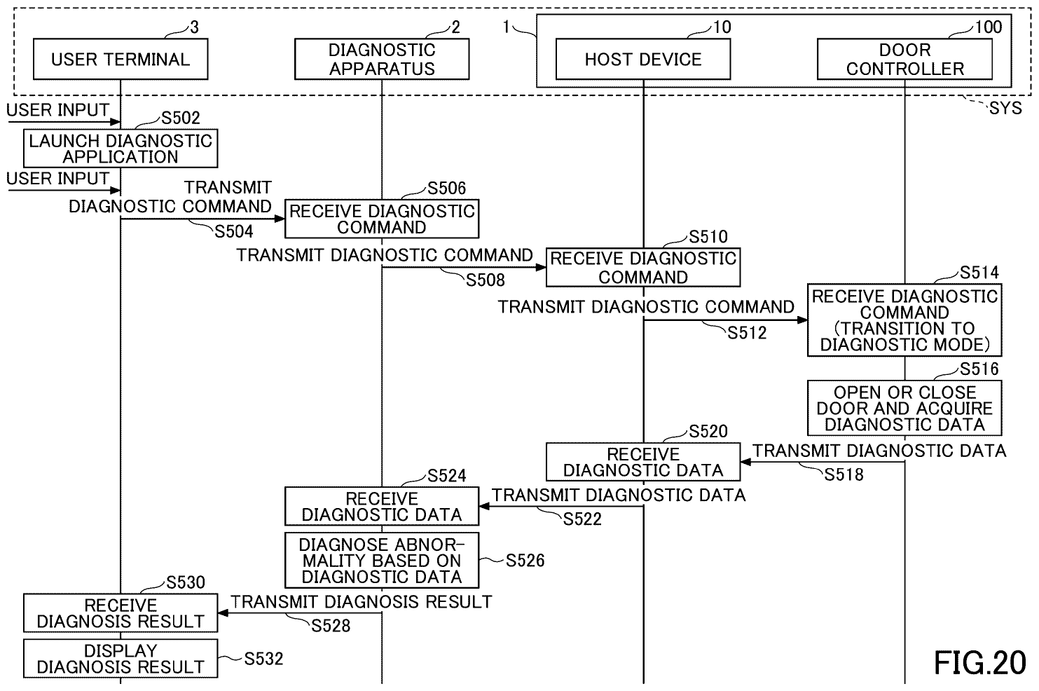

Hereinafter, a fifth example of the abnormality diagnosis process for the door 80 will be described with reference to FIG. 20.

FIG. 20 is a sequence diagram illustrating the fifth example of the abnormality diagnosis process for the door 80.

In this example, the diagnostic system SYS illustrated in FIG. 19 is used.

As illustrated in FIG. 20, the user terminal 3 launches a diagnostic application, in response to receiving a predetermined input from the user (step S502).

After the process in step S502 is completed, the user terminal 3 transmits a diagnostic command to the diagnostic apparatus 2, in response to receiving a predetermined input of a request from the user to perform abnormality diagnosis for the door 80 (step S504).

The diagnostic command transmitted from the user terminal 3, which is used at train carriages 1 having a plurality of cars, specifies a target train carriage 1 for which abnormality diagnosis is performed on one or more doors 80. The target train carriage 1 is specified using a predetermined input from the user.

The diagnostic apparatus 2 receives the diagnostic command transmitted from the user terminal 3 in the process in step S504 (step S506).

When the process in step S506 is completed, the diagnostic apparatus 2 relays the diagnostic command from the user terminal 3 to transmit the diagnostic command to the target train carriage 1 (the host device 10) (step S508).

The host device 10 (carriage controller 12) in the target train carriage 1 receives the diagnostic command transmitted in step S508 (step S510).

The carriage controller 12 relays the diagnostic command received in step S508 to transmit the diagnostic command to the door controller 100 via the transmission device 16 (step S512).

Steps S514, S516, S518, S520, S522, S524, and S526 are the same as steps S406, S408, S410, S412, S414, S416, and S418 in the fourth example (FIG. 18) described above, and description thereof is omitted.

When the process in step S526 is completed, the diagnostic apparatus 2 transmits a result of the abnormality diagnostic for the door 80 in step S526, to the user terminal 3 (step S528).

The user terminal 3 receives the result of the abnormality diagnostic transmitted from the diagnostic apparatus 2 in step S528 (step S530).

When the process in step S530 is completed, the user terminal 3 displays the result of the abnormality diagnosis for the door 80, on an output device (display device) of the user terminal 3 (step S532).

With this arrangement, the user can check the result of the abnormality diagnosis for the door 80, by using the user terminal 3.

As described above, in this example, in the

diagnostic system SYS, the user terminal 3 transmits a request (diagnostic command) to perform abnormality diagnosis for the door 80, to the train carriage 1 through the diagnostic apparatus 2, and then the user terminal 3 notifies the user of the result of the abnormality diagnosis for the door 80.

With this arrangement, with use of the user terminal 3, the user for the diagnostic system SYS can request a result of abnormality diagnosis for the door 80 to check the result of the abnormality diagnosis for the door 80. Therefore, for example, a user other than the user who can directly use the train carriage 1 or the diagnostic apparatus 2 can check the result of the abnormality diagnosis, by using the user terminal 3. For example, a person in charge of a manufacturer who handles service parts of one or more doors 80 can recognize a situation in which an abnormality occurs in one or more doors 80 for each car of the train carriage 1, and then optimize management or the like for the service parts. For example, a person who maintains and inspects one or more train carriages 1 can carry the user terminal 3, performs maintenance and inspection work for one or more doors 80 of an actually used train carriage 1, while checking the result of the abnormality diagnosis of each door 80. Therefore, convenience of the user for the diagnostic system SYS can be improved.

In this example, as in the second example (FIG. 15), when diagnostic data in the normal mode is acquired, the result of diagnosis may be provided to a user through the user terminal 3. In this case, in FIG. 20, steps S202, S204, S206, and S208 in FIG. 15 are adopted, instead of steps S502, S504, S506, S508, S510, S512, S514, and S516.

### Operation

Hereinafter, the operation of the diagnostic apparatus according to the present embodiment will be described.

In the present embodiment, a diagnostic apparatus includes a drive mechanism configured to open or close a door panel; a fastening mechanism configured to fasten the door panel to the drive mechanism; and circuitry configured to acquire first data related to an operation of a door of a train carriage during at least one of an opening operation or a closing operation of the door, and to diagnose an abnormality in the fastening mechanism based on the acquired data. The diagnostic apparatus includes, for example, the diagnostic apparatus 2, the car controller 12, or the door controller 100. The train carriage is, for example, the train carriage 1. The door is, for example, the door 80. The door panel is, for example, the door panel 80A or 80B. The drive mechanism is, for example, the door drive mechanism 200. The fastening mechanism is, for example, the fastening structure FS.

In the present embodiment, a diagnostic system includes a drive mechanism configured to open or close a door panel; a fastening mechanism configured to fasten the door panel to the drive mechanism; and circuitry configured to perform at least one of an opening operation or a closing operation of a door of a train carriage, acquire first data related to the operation of the door during the at least one of the opening operation or the closing operation, and diagnose an abnormality in the fastening mechanism based on the acquired first data. The diagnostic system is, for example, the diagnostic system SYS.

An information processing apparatus may execute a diagnosis method. Specifically, in the diagnosis method, the information processing apparatus acquires first data related to an operation of a door during at least one of an opening operation or a closing operation, and diagnoses, based on the acquired first data, an abnormality in a fastening mechanism configured to fasten a door panel to a drive mechanism that opens or closes the door panel.

A program may cause an information processing apparatus to execute a diagnostic method. The information processing apparatus includes, for example, the diagnostic apparatus 2, the car controller 12, or the door controller 100. Specifically, the program causes the information processing apparatus to acquire first data related to an operation of a door during at least one of an opening operation or a closing operation, to diagnose, based on the acquired first data, an abnormality in a fastening mechanism configured to fasten a door panel to a drive mechanism that opens or closes the door panel.

With this arrangement, the diagnostic

apparatus or the like can determine an effect, or a degree, of the inertia of the door panel due to looseness, breakage, or the like of the fastening mechanism between the door panel and the drive mechanism, based on the data related to the operation of the door of the train carriage that opens or closes. Thus, the diagnostic apparatus or the like can diagnose the abnormality in the fastening mechanism between the door panel and the drive mechanism.

In the present embodiment, the acquired first data may include second data related to at least one of an accelerated state or a decelerated state of the door. The diagnostic apparatus or the like may diagnose the abnormality based on the second data.

With this arrangement, the diagnostic apparatus or the like can determine the effect of inertia, or a degree of the inertia, of the door panel due to looseness, breakage, or the like of the fastening mechanism between the door panel and the drive mechanism, based on the data related to the door that accelerates and/or decelerates. As a result, the diagnostic apparatus or the like can diagnose the abnormality in the fastening mechanism between the door panel and the drive mechanism.

In the present embodiment, the accelerated state or the decelerated state of the door may be a state in which a speed command value that is generated by a controller to control the operation of the door changes in time. The controller is, for example, the door controller 100.

With this arrangement, the diagnostic apparatus or the like can use data related to the accelerated state and/or the decelerated state of the door, and the data includes data that is acquired in a period before a period in which the door accelerates in accordance with the speed command value. As a result, the diagnostic apparatus or the like can diagnose the abnormality in the fastening mechanism more appropriately.

In the present embodiment, the diagnostic apparatus or the like may directly or indirectly compare acquired first data or processed data that is obtained by processing the first data, with third data, the third data being related to an operation of at least one door, and being acquired in a case where the fastening mechanism is in a normal state. The diagnostic apparatus or the like may diagnose the abnormality based on a result of comparison. For example, the processed data includes frequency analysis data, or includes extraction data or the like that is obtained by extracting a portion from the acquired first data, where the portion is data related to the door that accelerates and/or decelerates.

With this arrangement, the diagnostic apparatus or the like can diagnose the abnormality in the fastening mechanism, using second data as a reference related to an operation of at least one door, in a case where the fastening mechanism is in a normal state.

In the present embodiment, the diagnostic apparatus or the like may diagnose the abnormality, using a trained model in which data related to the operation of doors in a case where the fastening mechanism is in a normal state is learned with supervised learning, where acquired data is input to the trained model.

With this arrangement, the diagnostic apparatus or the like can diagnose the abnormality in the fastening mechanism, using the trained model in which a normal state of the fastening mechanism is learned.

In the present embodiment, the diagnostic apparatus or the like may generate image data that is derived from acquired data, to diagnose the abnormality in the image data using a trained model to which the image data is input.

With this arrangement, the diagnostic apparatus or the like, or a learning apparatus that is separately provided from the diagnostic apparatus or the like, can generate a trained model using a segmentation model to which a known algorism is applied and to which image data can be input. Thus, the diagnostic apparatus or the like can perform abnormality diagnosis in which the trained model is more easily applied.

In the present embodiment, data related to the operation of the door in a case where the fastening mechanism is in a normal state may include operation-related data that is acquired at at least one of a timing at which the door starts operating or a timing that is immediately after maintenance of the door is performed.

With this arrangement, the diagnostic apparatus or the like can use the data related to the operation of the door in the case where the fastening mechanism is in the normal state.

In the present embodiment, the diagnostic apparatus or the like may acquire data related to the operation of the door that moves in a normal operating mode in which a passenger is to get on and off the train carriage. The normal mode is, for example, an operating mode of the door 80 in a case where the door controller 100 operates in the normal mode described above.

With this arrangement, the diagnostic apparatus or the like can acquire the data related to the operation of the door, for example, each time a train carriage stops at a station. Thus, the diagnostic apparatus or the like can diagnose the abnormality in the fastening mechanism based on the operation of the train carriage.

In the present embodiment, the diagnostic apparatus or the like may acquire data related to the operation of the door that moves in a diagnostic operating mode that is different from a normal operating mode in which a passenger is to get on and off the train carriage. The diagnostic mode is, for example, an operating mode of the door 80 in a case where the door controller 100 operates in a diagnostic mode.

With this arrangement, the diagnostic apparatus or the like can acquire can acquire data related to the operation of the door in (i) an operating mode in which the extent to which the door accelerates and/or decelerates is increased, compared to a normal operating mode, or (ii) the number of times the door accelerates and/or decelerates is increased, compared to the normal operating mode. In this case, the diagnostic apparatus or the like can determine the effect, or a degree, of the inertia, of the door panel due to looseness, breakage, or the like of the fastening mechanism, based on the data related to the operation of the door in the diagnostic mode. As a result, the diagnostic apparatus or the like can more accurately diagnose the abnormality in the fastening mechanism.

In the present embodiment, the diagnostic apparatus or the like may diagnose the abnormality based on processed data indicating a result of frequency analysis that is performed on acquired data. The processed data indicating the result of the frequency analysis is, for example, the diagnostic-frequency analysis data described.

With this arrangement, the diagnostic apparatus or the like can detect changes in a frequency component of the acquired data, based on the processed data indicating the result of the frequency analysis.

In the present embodiment, in the diagnostic apparatus or the like, acquired data may include data relating to a speed of the door, a current in a motor configured to drive the door, sound of the door, or vibration of the door.

With this arrangement, in an accelerated state and/or a decelerated state of the door, the diagnostic apparatus or the like can diagnose the abnormality in the fastening mechanism, based on data related to the door speed, the current in the motor, the sound, or the vibration.

Although the embodiments are described in detail above, the present disclosure is not limited to a specific embodiment, and various modifications and changes can be made within the scope of a gist described in the present disclosure.

In the aspects described above, an abnormality in a fastening mechanism between a door panel and a drive mechanism for opening or closing the door panel can be diagnosed.

What is claimed is:

1. A diagnostic apparatus comprising:
a drive mechanism configured to open or close a door panel;
a fastening mechanism configured to fasten the door panel to the drive mechanism; and
circuitry configured to:
acquire first data related to an operation of a door of a train carriage during at least one of an opening operation or a closing operation of the door, and
diagnose an abnormality in the fastening mechanism based on the acquired data.

2. The diagnostic apparatus according to claim 1, wherein the acquired first data includes second data related to at least one of an accelerated state or a decelerated state of the door, and
wherein the circuitry is configured to diagnose the abnormality based on the second data.

3. The diagnostic apparatus according to claim 1, wherein the circuitry is configured to:
directly or indirectly compare the acquired first data or processed data that is obtained by processing the first data, with third data, the third data being related to an operation of at least one door, and being acquired in a case where the fastening mechanism is in a normal state, and
diagnose the abnormality based on a result of comparison.

4. The diagnostic apparatus according to claim 3, wherein the third data includes a trained model in which the third data being related to the operation of doors, and being acquired in the case where the fastening mechanism is in the normal state, is learned with supervised learning, and
wherein the circuitry is configured to diagnose the abnormality, using the trained model to which the first data is input.

5. The diagnostic apparatus according to claim 4, wherein the circuitry is configured to:
generate image data based on the acquired first data, and
diagnose the abnormality using the trained model to which the image data is input.

6. The diagnostic apparatus according to claim 3, wherein the third data includes operation-related data of one or more doors in a case where the fastening mechanism is under a normal condition, the operation-related data being acquired at at least one of a timing at which the door starts operating or a timing that is immediately after maintenance of the door is performed.

7. The diagnostic apparatus according to claim 1, wherein the acquired first data includes data related to a movement operation of the door in a normal operating mode, of the fastening mechanism, in which a passenger is to get on and off the train carriage.

8. The diagnostic apparatus according to claim 1, wherein the acquired first data includes data related to a movement operation of the door in a diagnostic operating mode, the diagnostic operating mode being different from a normal operating mode in which a passenger is to get on and off the train carriage.

9. The diagnostic apparatus according to claim 1, wherein the circuitry is configured to diagnose the abnormality based on processed data indicating a result of frequency analysis that is performed on the first data.

10. The diagnostic apparatus according to claim 1, wherein the first data includes data relating to a speed of the door, a current in a motor configured to drive the door, sound of the door, or vibration of the door.

11. A diagnostic system comprising:
a drive mechanism configured to open or close a door panel;
a fastening mechanism configured to fasten the door panel to the drive mechanism; and
circuitry configured to:
perform at least one of an opening operation or a closing operation of a door of a train carriage,
acquire first data related to an operation of the door during the at least one of the opening operation or the closing operation, and
diagnose an abnormality in the fastening mechanism based on the acquired first data.

12. A diagnostic method executed by a computer, the diagnostic method comprising:
acquiring first data related to an operation of a door during at least one of an opening operation or a closing operation; and
diagnosing, based on the acquired first data, an abnormality in a fastening mechanism configured to fasten a door panel to a drive mechanism that opens or closes the door panel.

13. A non-transitory computer readable medium storing a program for causing a computer to execute the diagnostic method of claim 12.
